(19) United States
(12) Patent Application Publication
(10) Pub. No.: US 2015/0241630 A1
(43) Pub. Date: Aug. 27, 2015

(54) DIRECTIONAL COUPLER, AND MULTIPLEXER AND DEMULTIPLEXER

(71) Applicants: ROHM CO., LTD., Kyoto (JP); OSAKA UNIVERSITY, Osaka (JP)

(72) Inventors: Masayuki FUJITA, Osaka (JP); Tadao NAGATSUMA, Osaka (JP); Dai ONISHI, Kyoto (JP); Eiji MIYAI, Kyoto (JP)

(73) Assignees: ROHM CO., LTD., Kyoto (JP); OSAKA UNIVERSITY, Osaka (JP)

(21) Appl. No.: 14/633,129

(22) Filed: Feb. 26, 2015

(30) Foreign Application Priority Data
Feb. 27, 2014 (JP) 2014-036586

(51) Int. Cl. G02B 6/12; G02B 6/14; G02B 6/122; H04B 10/50; G02B 6/125; G02B 6/43; H04J 14/02; G02B 6/42; G02B 6/124

(52) U.S. Cl. CPC G02B 6/12007; G02B 6/4295; G02B 6/14; G02B 6/1225; G02B 6/124; G02B 6/125; G02B 6/43; H04J 14/02; H04B 10/501; G02B 2006/12035; G02B 2006/12147; G02B 2006/12078; G02B 2006/12061

(57) ABSTRACT

The directional coupler includes: lattice points periodically arranged in the 2D-PC slab and configured to diffract optical waves, THz waves, or millimeter waves in PBG frequencies in PBG structure of the 2D-PC slab in order to prohibit existence in a plane of the 2D-PC slab; a first 2D-PC waveguide formed of a line defect; a second 2D-PC waveguide which can be mode-coupled to the first waveguide; a directional coupling unit disposed between the first waveguide and the second waveguide in two rows, and having lattice points between waveguides of which the radius is smaller than that of the lattice points, wherein in order to match the first waveguide with an operational band at a side of an input port from the directional coupling unit, the width of the second waveguide is narrowed so that the whole dispersion curve of the directional coupling unit is moved to a higher-frequency side.

### CROSS REFERENCE TO RELATED APPLICATIONS AND INCORPORATION BY REFERENCE

This application is based upon and claims the benefit of priority from prior Japanese Patent Application No. P2014-36586 filed on Feb. 27, 2014, the entire contents of which are incorporated herein by reference.

### FIELD

An embodiment described herein relates to a directional coupler and a multiplexer and demultiplexer. The embodiment relates to in particular a directional coupler which can be miniaturized used for optical waves, terahertz (THz) waves, or millimeter waves, and a multiplexer and demultiplexer to which such a directional coupler is applied.

### BACKGROUND

In recent years, for THz wave band (0.1 THz to 10 THz) positioned in intermediate frequencies between electromagnetic waves and optical waves, studies of applicabilities of ultra high-speed wireless communications, sensing, imaging, etc. have become active, and there has been expected its practical application. However, since THz-wave systems are composed of large-sized and three-dimensional structured components under the current circumstances, large-sized and expensive configurations are required for such THz-wave systems. In order to miniaturize the whole of such systems, implementation of THz-wave integrated circuits (ICs) integrating devices is indispensable.

Utilization of technologies of both of an optical wave region and an electric wave region can be considered as fundamental technologies of the THz-wave ICs. However, optical components, e.g. lenses, mirrors, are composed of large-sized and three-dimensional structured components, and therefore are not suitable for the integration. Moreover, it is becoming difficult to produce hollow metal waveguides used in the electric wave region due to its fine three-dimensional structure. Furthermore, a waveguide loss in planar metallic-transmission lines is increased as effect of metallic absorption is increased.

As a fundamental technology of THz-wave ICs, there has been studied applicability of a two dimensional photonic crystal (2D-PC) slab where outstanding progress is seen in the optical wave region.

Moreover, there has been studied resonant and waveguiding line defect modes in an electromagnetic 2D band-gap (BG) slab structure for millimeter wave frequency bands.

Moreover, there has been realized multiplexers and demultiplexers using minute resonators in a wavelength-order size, in minuteness and integration of optical devices with the PC having a periodic refractive index profile.

Furthermore, in directional couplers using the PC, coupling length is miniaturized up to approximately wavelengths until now.

### SUMMARY

It is theoretically difficult to operate the multiplexer and demultiplexer using the resonator in broader bandwidths. Moreover, the sizes of ordinary optical multiplexers and demultiplexers are approximately several millimeters. Moreover, the optical multiplexer and demultiplexer using conventional micro PC directional couplers have narrower operational bands in a crossed state, such as approximately 0.2% of an operational frequency, and a degree of signal separation between a bar state and the crossed state is also as insufficient, such as less than 10 dB.

The embodiment provides a directional coupler which has a wide-band and high degree of signal separation and can be miniaturized, used for optical waves, THz waves, or millimeter waves, and a multiplexer and demultiplexer to which such a directional coupler is applied.

According to one aspect of the embodiment, there is provided a directional coupler comprising: a two dimensional photonic crystal slab; lattice points periodically arranged in the two dimensional photonic crystal slab, the lattice points configured to diffract optical waves, terahertz waves, or millimeter waves in photonic bandgap frequencies in photonic band structure of the two dimensional photonic crystal slab in order to prohibit existence in a plane of the two dimensional photonic crystal slab; a first two dimensional photonic crystal waveguide disposed in the two dimensional photonic crystal slab and formed with a line defect of the lattice points; a second two dimensional photonic crystal waveguide formed of a line defect of the lattice point in the two dimensional photonic crystal slab, mode coupling of the second two dimensional photonic crystal waveguide being realized to the first two dimensional photonic crystal waveguide; and a directional coupling unit disposed between the first two dimensional photonic crystal waveguide and the second two dimensional photonic crystal waveguide, the directional coupling unit including lattice points between waveguides, the size of the lattice points between waveguides is smaller than that of the lattice point.

According to another aspect of the embodiment, there is provided a multiplexer and demultiplexer comprising such a directional coupler.

According to the embodiment, there can be provided the directional coupler which has the wide-band and high degree of signal separation and can be miniaturized, used for optical waves, THz waves, or millimeter waves, and the multiplexer and demultiplexer to which such a directional coupler is applied.

### BRIEF DESCRIPTION OF DRAWINGS

FIG. 1 is a schematic bird's-eye view configuration diagram showing a directional coupler and a multiplexer and demultiplexer according to the embodiment.

FIG. 2 is an operational principle explanatory diagram of a PC directional coupler applied to the directional coupler according to the embodiment.

FIG. 3A shows a structural example of providing one input port and n-output ports, in a multiplexer and demultiplexer to which the directional coupler according to the embodiment is applied.

FIG. 3B shows a structural example of providing n-input ports and n-output ports, in a multiplexer and demultiplexer to which the directional coupler according to the embodiment is applied.

FIG. 4A shows a structural example of including one input port and two output ports, in an explanatory diagram of a design procedure of the multiplexer and demultiplexer to which the directional coupler according to the embodiment is applied.

FIG. 4B shows a structural example of providing an input port IP1 with an input waveguide and providing an output port OP2 with an output waveguide, in an explanatory diagram of the design procedure of the multiplexer and demultiplexer to which the directional coupler according to the embodiment is applied.

FIG. 4C shows a structural example of providing an output port OP1 with an output waveguide, in an explanatory diagram of the design procedure of the multiplexer and demultiplexer to which the directional coupler according to the embodiment is applied.

FIG. 5 is a schematic plane configuration diagram of a directional coupler according to the embodiment.

FIG. 6A is an explanatory diagram of a wavenumber direction, in the directional coupler according to the embodiment.

FIG. 6B shows a calculated example in a photonic band (PB) diagram showing a relationship between a normalized frequency and a normalized wavenumber, in the directional coupler according to the embodiment.

FIG. 6C is a schematic diagram of an ideal PB diagram, in the directional coupler according to the embodiment.

FIG. 7A shows an example of forming two states, in the PB diagram of the directional coupler according to the embodiment.

FIG. 7B shows an example of having a constant wavenumber difference, in the PB diagram of the directional coupler according to the embodiment.

FIG. 7C shows an example in which coupling is too strong, in the PB diagram of the directional coupler according to the embodiment.

FIG. 8 is a schematic planar pattern configuration diagram explaining an example of a PC slab applicable to the directional coupler according to the embodiment.

FIG. 9A shows an example of inserting lattice points in one row between PC waveguides, in the directional coupler according to the embodiment.

FIG. 9B shows an example of inserting lattice points in two rows between PC waveguides, in the directional coupler according to the embodiment.

FIG. 9C shows an example of inserting lattice points in three rows between PC waveguides, in the directional coupler according to the embodiment.

FIG. 10A shows an example of inserting lattice points in one row between PC waveguides, in a PB diagram of the directional coupler according to the embodiment.

FIG. 10B shows an example of inserting lattice points in two rows between PC waveguides, in the PB diagram of the directional coupler according to the embodiment.

FIG. 10C shows an example of inserting lattice points in three rows between PC waveguides, in the PB diagram of the directional coupler according to the embodiment.

FIG. 11A is an explanatory diagram of a radius r′ of the holes between waveguides in the case of inserting lattice points in two rows between PC waveguides, in the directional coupler according to the embodiment.

FIG. 11B is a PB diagram in the case of using the radius r′ of the holes between waveguides as a parameter, in the directional coupler according to the embodiment.

FIG. 12A is an explanatory diagram of a waveguide width shift amount s in the case of inserting lattice points in two rows between PC waveguides, in the directional coupler according to the embodiment.

FIG. 12B is a PB diagram in the case of using the waveguide width shift amount s of the holes between waveguides as a parameter, in the directional coupler according to the embodiment.

FIG. 13 shows an example of a diagram showing an obtained PB, in the directional coupler according to the embodiment.

FIG. 14 shows a simulation result of confirming a coupling length, in the directional coupler according to the embodiment.

FIG. 15 shows a simulation result of transmission characteristics, in the directional coupler according to the embodiment.

FIG. 16A shows a structure example of a directional coupler according to a comparative example.

FIG. 16B shows a structure example of a directional coupler according to the embodiment.

FIG. 17A shows a photograph of an experimental evaluation system for the purpose of an operation confirming of the directional coupler according to the embodiment.

FIG. 17B shows a photograph of a sample of a directional coupler applied to the experiment of the directional coupler according to the embodiment.

FIG. 17C is a schematic block configuration diagram of the experimental evaluation system corresponding to that shown in FIG. 17A.

FIG. 18 shows an experimental result of transmission characteristics, in the directional coupler according to the embodiment.

FIG. 19 is a schematic explanatory diagram showing a configuration of connecting directional couplers in parallel in order to realize broader bandwidths, in the directional coupler according to the embodiment.

FIG. 20A is a schematic explanatory diagram of broader bandwidths of the operational bands realized by connecting directional couplers in parallel, and is a schematic diagram showing operational bands B₃, B₂, B₁ overlapped one another, in the directional coupler according to the embodiment.

FIG. 20B is a schematic diagram of operational bands B₃∩B₂∩B₁ integrated and broadened, in the directional coupler according to the embodiment.

FIG. 21 is a planar pattern configuration diagram of structure of connecting the directional couplers according to the embodiment in parallel to three stages in order to realize broader bandwidths.

FIG. 22 is a planar pattern configuration diagram of structure of connecting the directional couplers according to the embodiment in parallel to two stages.

FIG. 23 shows a simulation result of frequency characteristics (transmission spectrum) of transmittance T (dB), in the directional couplers according to the embodiment having structure of being connected in parallel to two stages corresponding to that shown in FIG. 22.

FIG. 24A shows a simulation result of an electromagnetic field distribution from port P1 to port P3 (cross) state in the case of frequency f=0.32 THz.

FIG. 24B shows a simulation result of an electromagnetic field distribution from port P1 to port P3 (cross) state in the case of frequency f=0.33 THz.

FIG. 24C shows a simulation result of an electromagnetic field distribution from port P1 to port P2 (bar) state in the case of frequency f=0.34 THz.

FIG. 25A shows another structural examples of the directional coupler according to the embodiment, showing a structural example of a directional coupler according to a modified example 1.

FIG. 25B shows another structural examples of the directional coupler according to the embodiment, showing a structural example of a directional coupler according to a modified example 2.

FIG. 25C shows another structural examples of the directional coupler according to the embodiment, showing a structural example of a directional coupler according to a modified example 3.

FIG. 25D shows another structural examples of the directional coupler according to the embodiment, showing a structural example of a directional coupler according to a modified example 4.

FIG. 26A shows a periodic structure of lattice points which is an example of arrangement in a square-lattice shape, in a 2D-PC slab applicable to both of the directional coupler and the multiplexer and demultiplexer according to the embodiment.

FIG. 26B is a band structure diagram of the 2D-PC slab corresponding to the arrangement shown in FIG. 26A.

FIG. 27A shows a periodic structure of lattice points which is an example of arrangement in a triangular-lattice shape, in a 2D-PC slab applicable to both of the directional coupler and the multiplexer and demultiplexer according to the embodiment.

FIG. 27B is a band structure diagram of the 2D-PC slab corresponding to the arrangement shown in FIG. 27A.

FIG. 28A shows a periodic structure of lattice points which is an example of arrangement in a rectangular-lattice shape, in a 2D-PC slab applicable to both of the directional coupler and the multiplexer and demultiplexer according to the embodiment.

FIG. 28B is a band structure diagram of the 2D-PC slab corresponding to the arrangement shown in FIG. 28A.

FIG. 29A shows a periodic structure of lattice points which is an example of arrangement in a rhombic-lattice shape, in a 2D-PC slab applicable to both of the directional coupler and the multiplexer and demultiplexer according to the embodiment.

FIG. 29B is a band structure diagram of the 2D-PC slab corresponding to the arrangement shown in FIG. 29A.

### DESCRIPTION OF EMBODIMENTS

Next, a certain embodiment will now be described with reference to drawings. In the description of the following drawings, the identical or similar reference numeral is attached to the identical or similar part. However, it should be noted that the drawings are schematic and the relation between thickness and the plane size and the ratio of the thickness of each component part differs from an actual thing. Therefore, detailed thickness and size should be determined in consideration of the following explanation.

Of course, the part from which the relation and ratio of a mutual size differ also in mutually drawings is included. Moreover, the embodiment described hereinafter merely exemplifies the apparatus and method for materializing the technical idea; and the embodiment does not specify the material, shape, structure, placement, etc. of each component part as the following. The embodiment may be changed without departing from the spirit or scope of claims.

### Embodiment

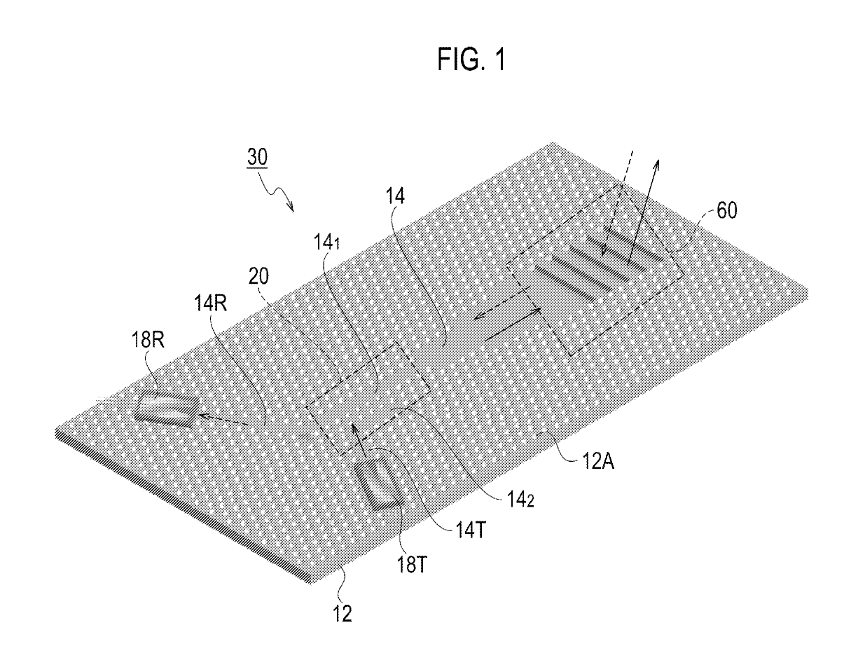

FIG. 1 shows a schematic bird's-eye view configuration of a directional coupler 20 and a multiplexer and demultiplexer 30 according to the embodiment.

As shown in FIG. 1, the multiplexer and demultiplexer 30 according to the embodiment includes: a directional coupler 20; an input/output interface 60 coupled to the directional coupler 20 via a 2D-PC waveguide 14; a detector 18R coupled to the directional coupler 20 via a 2D-PC waveguide 14R; and a transmitter (light source) 18T coupled to the directional coupler 20 via a 2D-PC waveguide 14T.

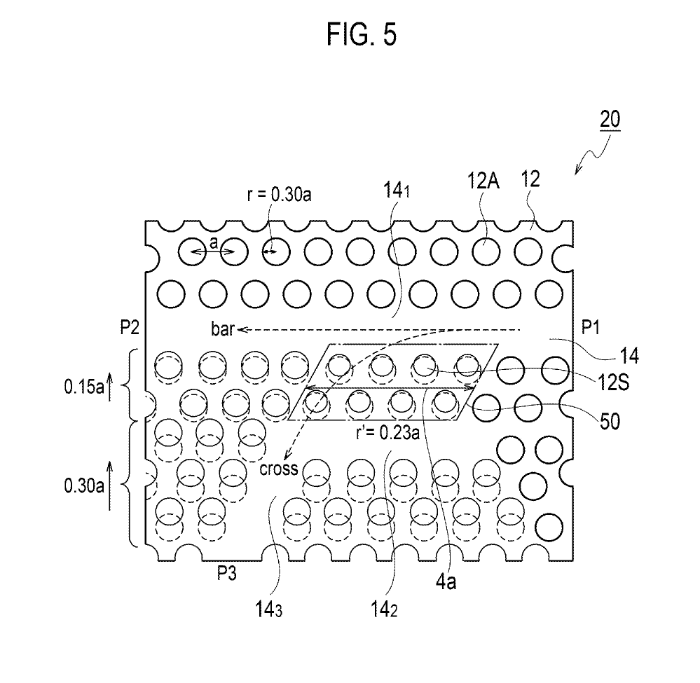

Although the directional coupler 20 includes 2D-PC waveguides 14₁, 14₂ separated for the distance amount of two rows of lattice points, for example, a detailed configuration will be mentioned below (in FIG. 5).

The input/output interface 60 is a coupler from free space, and is composed of a grating coupler composed of a one-dimensional PC, for example. The input/output interface 60 can also be composed by using 2D-PC.

The detector 18R can be composed of a THz wave receiver on which a Resonant Tunneling Diode (RTD) etc. is mounted, or a Schottky Barrier Diode (SBD), for example.

The transmitter (light source) 18T can be composed of a THz wave transmitter on which RTD etc. is mounted, or a semiconductor laser. In this case, the following are applicable as materials of the semiconductor laser, for example. That is, for example, GaInAsP/InP based materials are applicable in the case of wavelengths of 1.3 μm to 1.5 μm; InGaAs/GaAs based materials are applicable in the case of an infrared light with a wavelength of 900 nm; GaAlAs/GaAs based or GaInNAs/GaAs based materials are applicable in the case of an infrared light/near-infrared light with wavelengths of 800 to 900 nm; GaAlInAs/InP based materials are applicable in the case of wavelengths of 1.3 μm to 1.67 μm; AlGaInP/GaAs based materials are applicable in the case of a wavelength of 0.65 μm; and GaInN/GaN based materials are applicable in the case of a blue light.

The multiplexer and demultiplexer 30 according to the embodiment can propagate optical waves, THz waves, or millimeter waves.

As shown in FIG. 1, the directional coupler 20 and the multiplexer and demultiplexer 30 according to the embodiment includes: a 2D-PC slab 12; and lattice points 12A periodically arranged in the 2D-PC slab 12, the lattice points 12A configured to diffract optical waves, THz waves, or millimeter waves in Photonic BandGap (PBG) frequencies in PB structure of the 2D-PC slab 12 in order to prohibit existence in a plane of the 2D-PC slab 12.

The 2D-PC waveguide 14, 14₁, 14₂, 14_{R}, 14_{T} are disposed on the 2D-PC slab 12 and is formed of a line defect of the lattice points 12A.

### (Operational Principle)

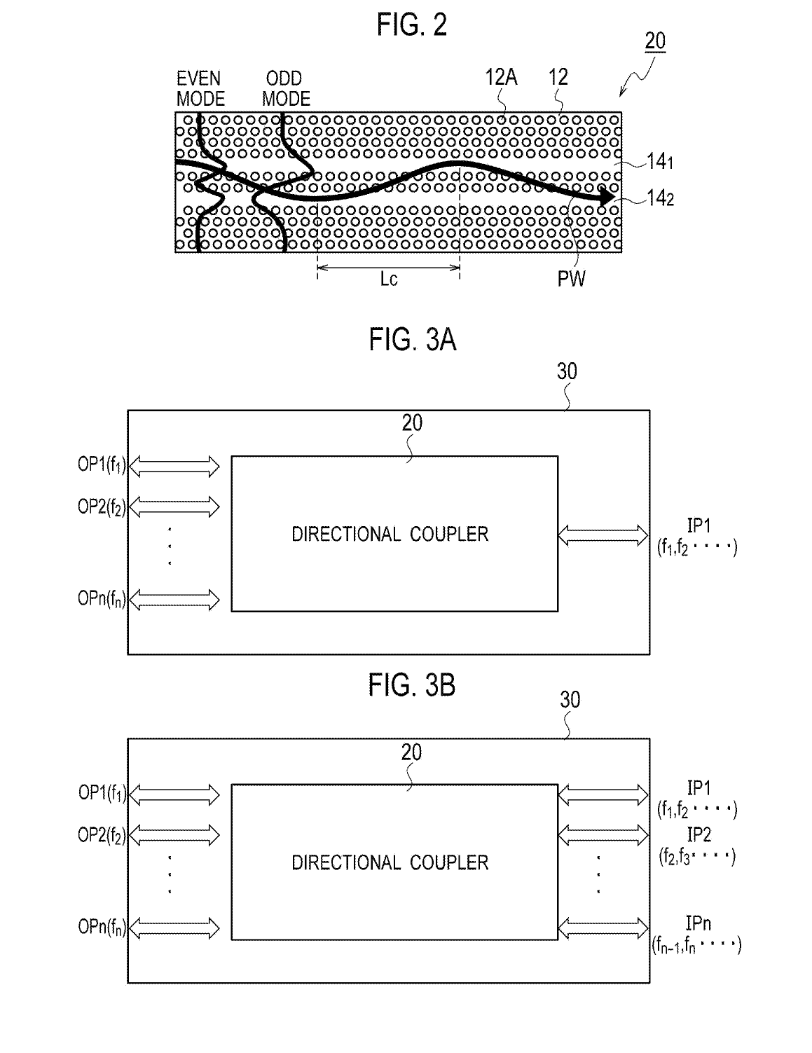

FIG. 2 shows an operational principle explanatory of the PC directional coupler applied to the directional coupler according to the embodiment.

The directional coupler is a device for extracting a signal propagated in a specific direction in a transmission line, and has frequency selectivity slowly than that of a resonator.

As shown in FIG. 2, a theoretic configuration of the directional coupler 20 according to the embodiment includes: a 2D-PC slab 12; lattice points 12A periodically arranged in the 2D-PC slab 12, the lattice points 12A configured to diffract optical waves, THz waves, or millimeter waves in PBG frequencies in PB structure of the 2D-PC slab 12 in order to prohibit existence in a plane of the 2D-PC slab 12; a first 2D-PC waveguide 14₁ disposed in the 2D-PC slab 12, the first 2D-PC waveguide 14₁ formed of a line defect of the lattice points 12A; and a second 2D-PC waveguide 14₂ disposed so as to be separated from and in parallel with the first 2D-PC waveguide 141, the second 2D-PC waveguide 14₂ similarly formed of a line defect of the lattice points 12A in the 2D-PC slab 12.

As shown in FIG. 3, the directional coupler 20 theoretically generates an even mode (EVEN) and an odd mode (ODD) by disposing two waveguides composed of the first 2D-PC waveguide 14₁ and the second 2D-PC waveguide 14₂ so as to be adjacent to each other, and thereby a propagation signal PW having a coupling length L_{C} can be propagated in an extending direction of the 2D-PC waveguides 14₁, 14₂ by using an interference effect between the even mode and the odd mode. In this case, the coupling length L_{C} corresponds to the minimum signal propagation distance required for a mode conversion between the even mode and the odd mode, as shown in FIG. 3. According to a simple design, the coupling length L_{C} is approximately 100 times to several hundred times of a period of the lattice points 12A, and approximately several tens of times to 100 time of the operating wavelength thereof.

The directional coupler 20 according to the embodiment has a large operational band, and can secure sufficient degree of signal separation, and can be miniaturized as explained below in detail, with respect to the above-mentioned theoretic configuration. Moreover, the directional coupler 20 can propagate the optical waves, THz waves, or millimeter waves.

### (Multiplexer and Demultiplexer)

The multiplexer and demultiplexer has a signal processing function for switching a path of light and a path of electromagnetic wave in accordance with the frequencies (wavelengths). In the directional coupler according to the embodiment can be miniaturized and integrated by applying the 2D-PC.

FIG. 3A shows a structural example of providing one input port and n-output ports, and FIG. 3B shows a structural example of providing n-input ports and n-output ports, in the multiplexer and demultiplexer to which the directional coupler according to the embodiment is applied.

Although FIG. 3A shows a structural example of one input port, it can also be configured as multi-input ports as shown in FIG. 3B. Moreover, it can be configured so that the operational frequencies of each port are overlapped with each other.

There will be mainly explained a structural example of one input port and two output port for the sake of simplifying the detailed structure of the PC slab, but it is also possible to configure to provide both of multi-input ports and multi-output ports.

### (Design Procedure of Multiplexer and Demultiplexer)

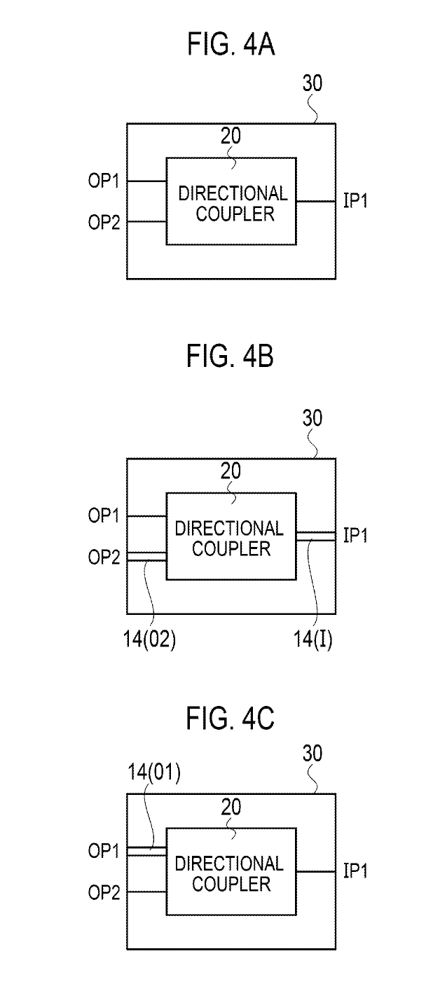

There will now be explained a design procedure of the multiplexer and demultiplexer 30 to which the directional coupler 20 according to the embodiment is applied, with reference to FIGS. 4A-4C. Although an example of one input port and two output ports is shown for the sake of simplifying, multi-input ports and multi-output ports can also be similarly designed.

FIG. 4A shows a structural example providing one input port (IP1) and two output ports (OP1, OP2) each connected to the directional coupler 20. FIG. 4B shows a structural example of providing an input waveguide 14(I) between the directional coupler 20 and the input port IP1, and providing an output waveguide 14(02) between the directional coupler 20 and the output port OP2. Moreover, FIG. 4C shows a structural example of providing an output waveguide 14(01) between the directional coupler 20 and the output port OP1.

Step (a): firstly, the directional coupler 20 is designed using a PB diagram so that broader bandwidths and small operation can be achieved as much as possible, as shown in FIG. 4A. Thereby, it is possible to operate as the directional coupler 20.

Step (b): next, the design of the directional coupler 20, or the input waveguide 14(I) and the output waveguide 14(02) is changed so that a band of the input waveguide 14(I) and the output waveguide 14 (02) is matched to that of the directional coupler 20.

The above-mentioned steps (a) and (b) are fundamentally required as the multiplexer and demultiplexer 30.

Step (c): ideally, it is an operation to be output only to the port OP2 at one side in a certain frequency, but actually, an output component to another port OP1 also exist. In order to reduce an excessive output to another port OP1 and to improve a degree in separation (ratio between the output to main port OP2 and the output to another port OP1), the design is changed so that an interrupt of the signal propagation to the output waveguides 14 except for main port OP2(01) can be achieved. Thereby, the signal separative performance of the multiplexer and demultiplexer 30 can be further improved.

### (Structural Example of Directional Coupler)

FIG. 5 shows a schematic plane configuration of the directional coupler 20 according to the embodiment.

As shown in FIG. 5, the 2D-PC waveguides 14₁, 14₂ composed of one-row line defect formed in a gamma-J direction of the 2D-PC slab 12, in which the triangular lattice circular holes 12A are arranged, are formed to be adjacent to each other with a coupling length L_{C}=4a (where a is a period of the lattice points 12A: lattice constant), thereby forming the directional coupler 20. However, a is the lattice constant of the triangular lattice, and the radius r of air holes is set to 0.30a, and the thickness and the refractive index of the 2D-PC slab 12 are respectively set to 0.83a and 3.4.

The following configurations are adopted for the directional coupler 20 according to the embodiment.

(a) The separation distance between the 2D-PC waveguides 14₁, 14₂ is formed by inserting the lattice points in two rows between the PC waveguides so that the even mode and the odd mode occur in the 2D-PC waveguides 14₁, 14₂ portions are coupled to each other and the mode spacing becomes as large as possible. In this case, the holes between waveguides (lattice points) arranged at two rows are illustrated with reference numeral 12S.
(b) The radius r′ of the circular holes between the waveguides is set to 0.23 time of the period a so that the propagation constant of the even mode and odd mode may become constant over the broader frequency ranges as possible.
(c) In order to be matched to the operational band of the 2D-PC waveguide 14 of the input port (port P1), the waveguide width of the 2D-PC waveguide 14₂ is formed to be narrowed only 0.15a so that the whole dispersion curve of the directional coupling unit 50 is be moved to the higher-frequency side. In this case, the waveguide width of the 2D-PC waveguide 14₂ is formed to be narrowed only 0.3a at first, and then as a result of which the width of the 2D-PC waveguide 14₁ is formed to be narrowed only 0.15a as mentioned below, thereby finally is formed to be narrowed only 0.15a, up to 0.3a-0.15a.
(d) In order to improve a degree in separation between the bar state (ports P1 to P2) and the crossed state (ports P1 to P3), the width of the 2D-PC waveguide 14₁ connected from the directional coupling unit 50 to the port P2 is formed to be narrowed only 0.15a to form a mode gap to the port P2 in the frequency band of cross operation.

### (Miniaturizing and Broader Bandwidth of Directional Coupler)

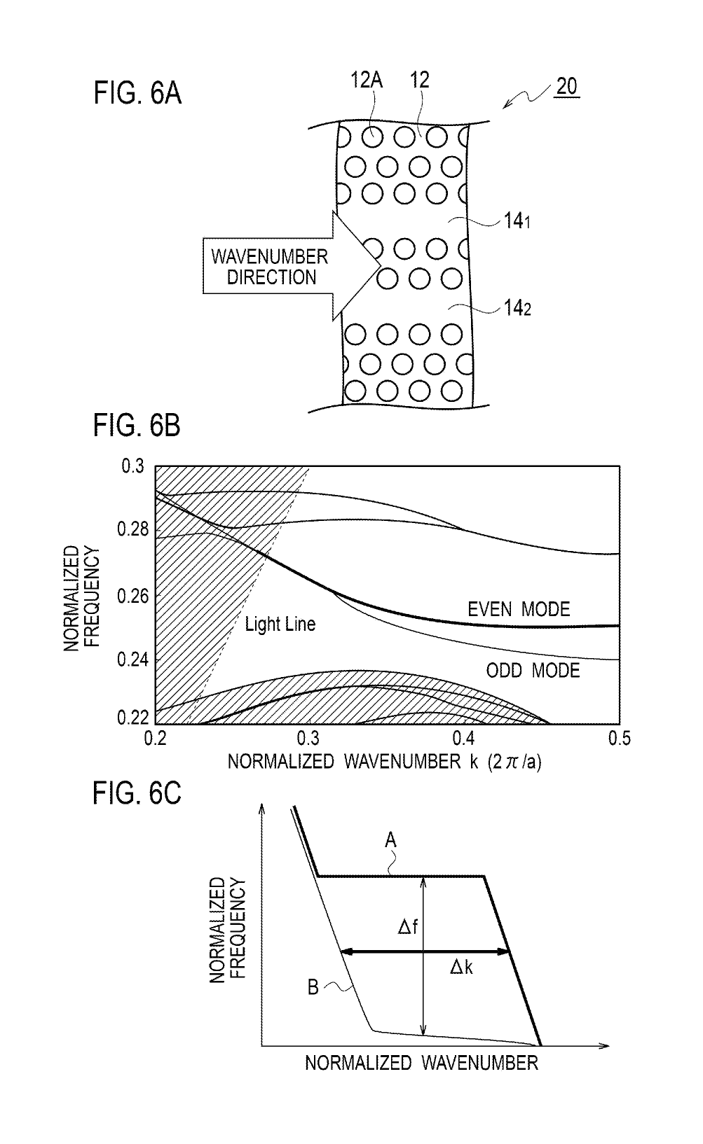

FIG. 6A shows an explanatory diagram of a wavenumber direction, FIG. 6B shows a calculated example of a PB diagram showing a relationship between a normalized frequency and a normalized wavenumber, and FIG. 6C shows a schematic ideal PB diagram. In FIG. 6C, the curve A corresponds to the even mode and the curve B corresponds to the odd mode.

Calculation of a propagation mode in a wavenumber direction of the arrow shown in FIG. 6A generates the even mode and the odd mode, as shown in FIG. 6B. A wavenumber difference Δk between these two modes determines the coupling length L_{C}. A broader bandwidth is realized if the wavenumber difference Δk with the same value can be kept in larger frequency bands. Moreover, the directional coupler can be miniaturized as the wavenumber difference Δk becomes large, since the coupling length L_{C} is determined with the inverse number of the wavenumber difference Δk. That is, if such a band diagram having an ideal form is realizable as shown in FIG. 6C, there can be realized a small coupling structure having broader bandwidths and short coupling length L_{C}.

According to the directional coupler 20 according to the embodiment, since the wavenumber difference Δk can be made smaller in order to be constantly held over the broader bandwidths of frequency difference Δf, it is possible to realize broader bandwidths and miniaturizing of the directional coupler for optical waves, THz waves, or millimeter waves.

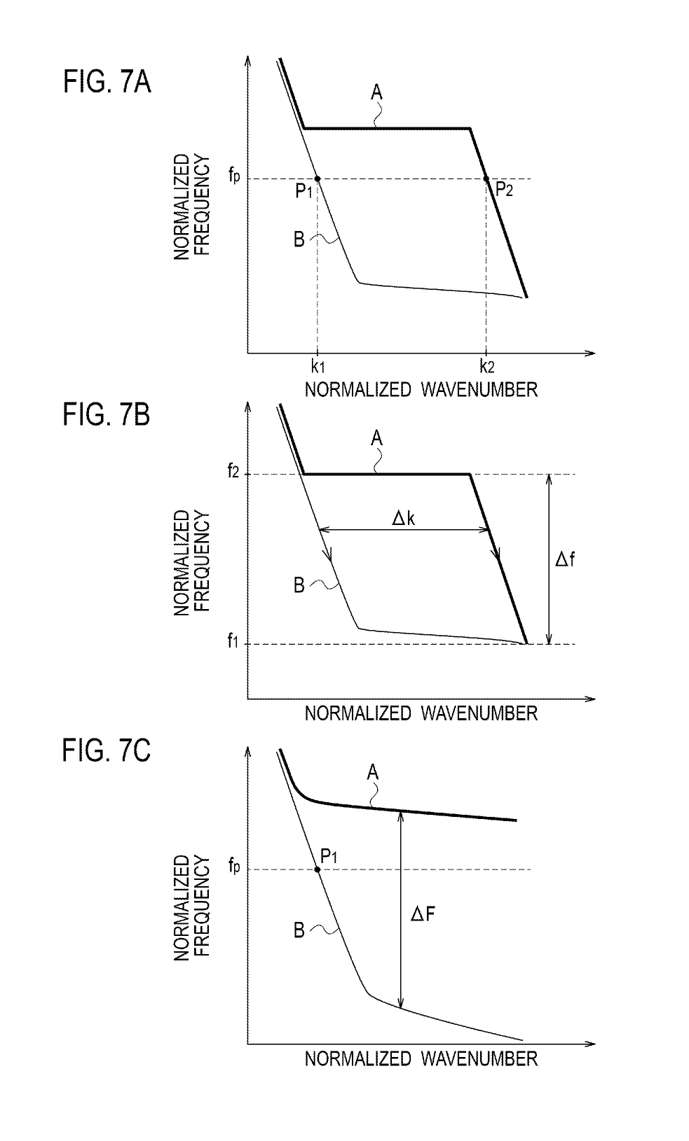

FIG. 7A shows an example of forming two states, an even mode and an odd mode, FIG. 7B shows an example of having a constant wavenumber difference, and FIG. 7C shows an example in which coupling is too strong, in a PB diagram of the directional coupler according to the embodiment. Moreover, in FIGS. 7A-7C, the curve A corresponds to the even mode and the curve B corresponds to the odd mode.

In the directional coupler according to the embodiment, the even mode and the odd mode are generated by forming two waveguides to be adjacent to each other, in order to use an interference effect between the even mode and the odd mode.

In the directional coupling, as shown in FIG. 7A it is necessary to make two states (even mode and odd mode) where the frequency f is same as each other but the wavenumbers k is different from each other. As shown in FIG. 7A, two operational points P₁, P₂ have different normalized wavenumbers k1, k2 with respect to the same frequency fₚ.

Although the even mode and the odd mode are generated by coupling two waveguide modes, a degree of decoupling of a state in the mode (frequency and wavenumber) is proportional to a strength of coupling of two waveguides. That is, the degree of decoupling is equal to the wavenumber difference Δk and the frequency difference Δf between the even mode and the odd mode, as shown in FIG. 6B.

In the directional coupler according to the embodiment, the degree of decoupling is increased and thereby miniaturizing and broader bandwidth thereof are possible, as the strength of coupling of two 2D-PC waveguides 14₁, 14₂ becomes stronger. This is because the coupling length L_{C} is proportional to the inverse number of wavenumber difference Δk (1/Δk).

Moreover, as shown in FIG. 7B, the physical coupling length L_{C} is constant, and the wavenumber difference Δk of the constant value corresponding to the coupling length L_{C} can be obtained in broader bandwidths of the frequency difference Δf. That is, it is necessary for broader bandwidth to set the propagation constant proportional to the inverse number of inclination of the dispersion curve of PB diagram to be constant at the even mode and the odd mode.

However, as shown in FIG. 7C, if the coupling is too strong, the frequency difference ΔF becomes large, the decoupling of two states becomes too large, and thereby it becomes impossible to keep two wavenumber states with single frequency. Accordingly, it becomes impossible to satisfy conditions for making two states (even mode and odd mode) where the frequency fₚ is the same as each other and the wavenumbers k are different from each other. That is, it is necessary to set a properly strength of the coupling.

A dispersion relation which is a relationship between these frequencies f and the wavenumber k is obtained with the PB diagram. In the PC, the dispersion relation can be flexibly adjusted by using a structural parameter, and coupling between the waveguide modes can be strengthened since optical confinement to the waveguide is strong.

### (Illustrative Example of PC Slab)

The 2D-PC slab 12 includes a dielectric plate structure having 2D periodic structure. In the 2D-PC slab 12, PBG in which the electromagnetic mode cannot exist appears by the design thereof. Furthermore, the waveguide mode can be introduced in the PBG by disturbing the periodic structure, and thereby a low-loss waveguide in a micro region equal to or less than the wavelength size thereof can be realized.

In this case, the bandwidth of PBG depends on a refractive index of dielectrics, and therefore high-refractive index materials are preferable to be adapted therefor.

Materials of the 2D-PC slab 12 applicable to the directional coupler 20 according to the embodiment may be formed with semiconducting materials.

Since the directional coupler according to the embodiment can propagate the optical waves, THz waves, or millimeter waves, it can apply the following as the semiconducting materials. More specifically, silicon (Si), GaAs, InP, GaN, etc. are applicable thereto, and GaInAsP/InP based, GaInAs/GaAs based, GaAlAs/GaAs based or GaInNAs/GaAs based, GaAlInAs/InP based, GaAlInP/GaAs based, GaInN/GaN based materials, etc. are applicable thereto. In particular, high resistivity Si has a high refractive index in the THz wave bands, and therefore there is little material absorption.

In addition, the lattice point for resonator 12A may be formed as an air hole, or may be filled up with a semiconductor layer differing in the refractive index, for example. For example, the lattice point may be formed by a GaAs layer filled up with a GaAlAs layer.

Moreover, it is possible to adapt as the lattice point (hole) 12A not only the structure where the hole of air is formed, but the structure where (a part of) the hole is filled up with a low-refractive index (low-dielectric constant) medium. Polymeric materials, e.g. Teflon, fluorine contained resin, a polyimide, acrylic, polyester, an epoxy resin, a liquid crystal, a polyurethane, etc. are applicable to the low-refractive index (low-dielectric constant) medium, for example. As a low-refractive index (low-dielectric constant) medium, dielectrics, e.g. SiO₂, SiN, SiON, an alumina, and a sapphire, are also applicable, for example. Moreover, porous bodies, e.g. an aerogel, etc. are also applicable to the low-refractive index (low-dielectric constant) medium.

Moreover, not only the semiconductor materials but also the high-refractive index medium can be applied, as the materials of the 2D-PC slab 12. For example, magnesium oxide (MgO) is applicable to the 2D-PC slab 12 since the refractive index in the THz wave band becomes approximately 3.1 which is high dielectric (insulator).

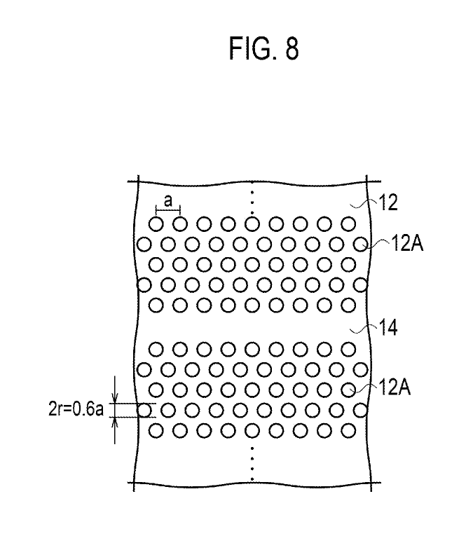

FIG. 8 shows a planar pattern configuration of an illustrative example of the PC slab applicable to the directional coupler according to the embodiment.

The 2D-PC slab 12 applicable to the directional coupler according to the embodiment can be formed with a silicon, for example. Furthermore, as shown in FIG. 8, the lattice points 12A periodically arranged in the 2D-PC slab 12, the lattice points 12A configured to diffract optical waves, THz waves, or millimeter waves in PBG frequencies in PB structure of the 2D-PC slab 12 in order to prohibit existence in a plane of the 2D-PC slab 12 respectively include circular holes, and are arranged in a 2D triangular lattice shape, for example. The diameter 2r of the lattice point 12A is equal to 0.6a with respect to the lattice constant (period) a of the lattice point 12A, for example. That is, the structure of the PC slab in which the 2D triangular lattice circular holes of which the radius r is 0.30 times longer than the period a are periodically formed in a silicon is fundamental structure. Fundamental 2D-PC waveguide 14 is disposed in the 2D-PC slab 12, and is formed with a line defect of the lattice points 12A. For example, the fundamental 2D-PC waveguide 14 can be formed by filling one row of the holes of periodic structure. For example, if 0.3-THz frequencies are assumed, the period a=240 μm is realized.

According to the electromagnetic field simulation result of the relationship between the lattice constant a of the lattice points 12A and the PGB frequency which are periodically arranged in the 2D-PC slab 12, the PGB frequency band can be varied to higher frequency by making the lattice constant small. For example, the PGB frequency band is appeared ranging from approximately 0.9 to approximately 1.1 THz in the lattice constant a=80 μm, ranging from approximately 0.31 THz to approximately 0.38 THz in the lattice constant a=240 μm (experiment structure), and ranging from approximately 0.10 THz to approximately 0.12 THz in the lattice constant a=750 μm.

Moreover, handling frequency bands are not limited to the THz wave band, but a general optical waves are also included. In this case, as the 2D-PC slab 12, the lattice constant a of the lattice points 12A is miniaturized, and thereby the operating wavelength may be set as ranging from approximately 1 μm to 2 μm bands, and the lattice constant is set as ranging from approximately 250 nm to approximately 500 nm, etc., for example. Moreover, the diameter and the depth of the lattice points 12A are respectively approximately 200 nm and approximately 300 nm, for example. The numerical examples can be appropriately changed according to materials, a wavelength, etc. to compose the 2D-PC slab 12. For example, in the 2D-PC slab 12 to which GaAs/GaAlAs based materials are applied, the wavelength is approximately 200 nm to approximately 400 nm.

(Variation of Dispersion Relationship in the Case where the Row Numbers Between Waveguides is Different from One Another)

Next, there will now be explained a method to vertically narrow the mode spacing. The row number of holes between the 2D-PC waveguides 14₁, 14₂ is varied in order to adjust the strength of coupling between two 2D-PC waveguides 14₁, 14₂.

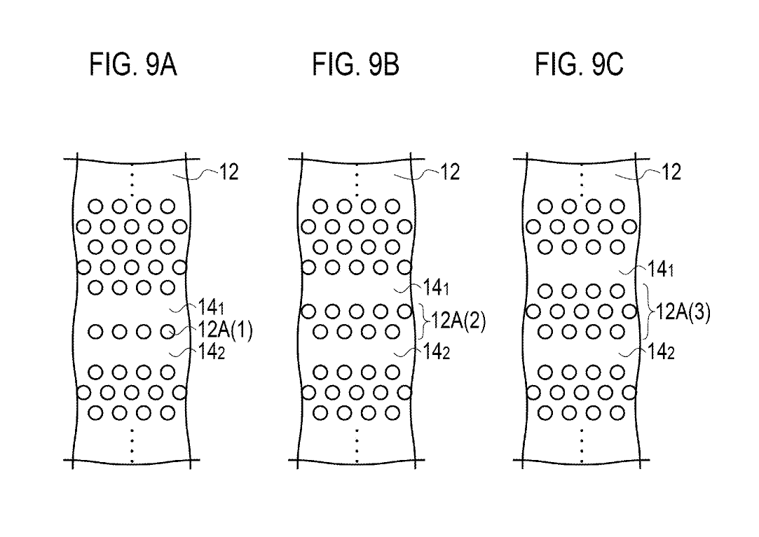

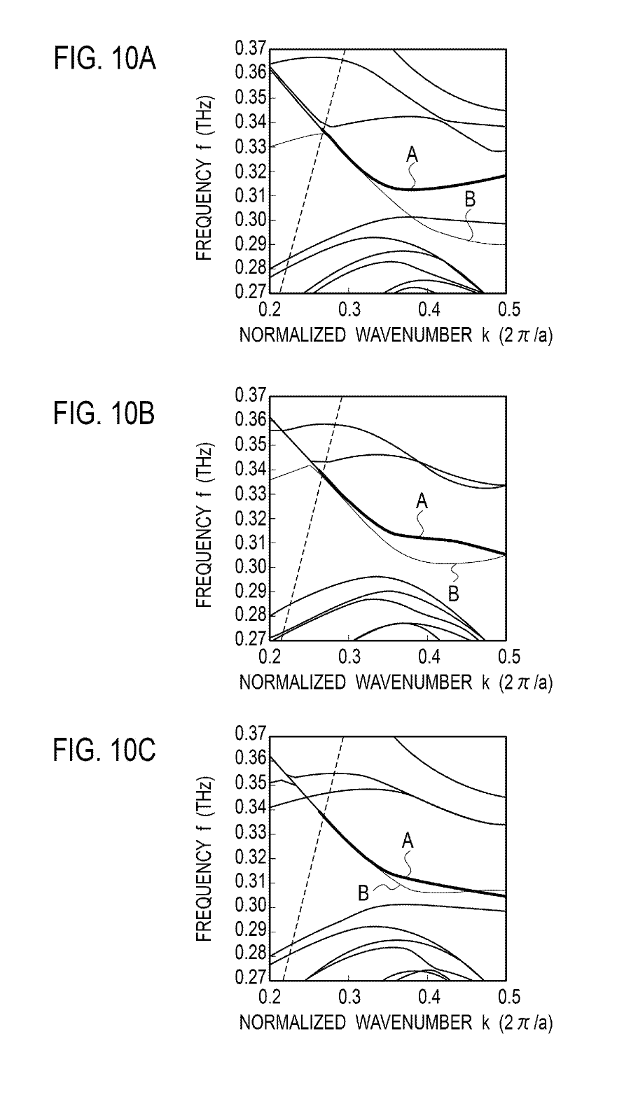

In the directional coupler according to the embodiment, FIG. 9A shows an example of inserting the lattice points 12A(1) in one row between the 2D-PC waveguides 14₁, 14₂, FIG. 9B shows an example of inserting the lattice points 12A(2) in two rows between the 2D-PC waveguides 14₁, 14₂, and FIG. 9C shows an example of inserting the lattice points 12A(3) in three rows between the 2D-PC waveguides 14₁, 14₂. Moreover, FIGS. 10A, 10B, and 10C respectively show PB diagrams corresponding to those in FIGS. 9A, 9B, and 9C. The curve A corresponds to the even mode and the curve B corresponds to the odd mode.

The coupling strength between the waveguide modes becomes strong as the space between the 2D-PC waveguides 141, 142 becomes narrow, as shown in FIGS. 10A, 10B, and 10C. As a result, the degree of decoupling between the modes becomes large. In particular, the spacing of inserting two-row lattice points is suitable for broader bandwidth and miniaturizing compared with the spacing of inserting three-row lattice points. On the other hand, the coupling strength is too strong if the spacing of inserting one-row lattice points, and therefore it is difficult to be used as the directional coupler since the two states cannot be obtained at single frequency.

The mode coupling cannot be obtained in the example of inserting the lattice points 12A(1) in one row between the 2D-PC waveguides 14₁, 14₂, as shown in FIG. 10A. On the other hand, it is difficult to obtain sufficient bands in the example of inserting the lattice points 12A(3) in three rows between the 2D-PC waveguides 14₁, 14₂. In the example of inserting the lattice points 12A(2) in two rows between the 2D-PC waveguides 14₁, 14₂, there can be obtained the optimal structure which can realize the mode coupling and can also secure the bands.

It is proved that the mode spacing vertically narrows as the row number between the line defects are increased, in the variation of dispersion property at the time when the row number of holes for separating two waveguides is changed. At this time, if the row number is one, the sufficient coupling can be realized since the size of the mode spacing is too great. Moreover, if three rows thereof are used, the mode spacing becomes narrow, but the sufficient bands cannot be fully secured. That is, the row number is optimally two since the sufficient mode coupling can be realized and the sufficient bands can secured.

### (Radius Dependency of Dispersion Relationship of Holes Between Waveguides: Adjustment of Radius)

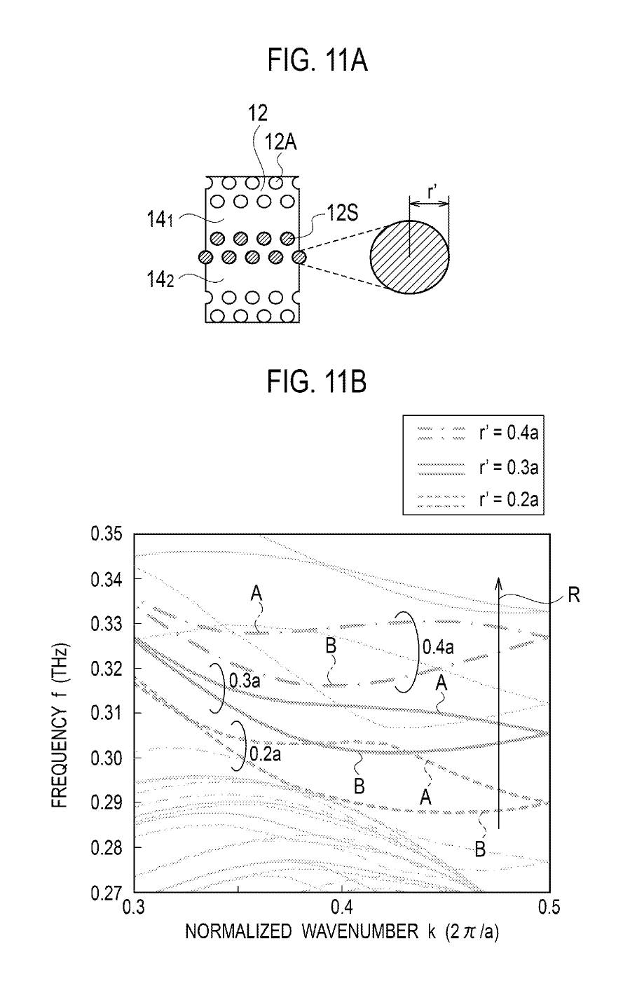

In the directional coupler 20 according to the embodiment, FIG. 11A shows an explanatory diagram of the radius r′ of holes between waveguides in the case of inserting the lattice points in two rows between the 2D-PC waveguides 14₁, 14₂, and FIG. 11B shows a PB diagram in which the radius r′ of holes between the waveguides is used as a parameter.

FIGS. 11A and 11B show an example of the space in which the lattice points in two rows are inserted between the 2D-PC waveguides 14₁, 14₂, and the radius r′ of holes 12S between the waveguides is varied to 0.4a, 0.3a, or 0.2a. The curve A corresponds to the even mode and the curve B corresponds to the odd mode.

In the directional coupler 20 according to the embodiment, the strength of the coupling between the 2D-PC waveguides 14₁, 14₂ can be varied also by varying the radius r of holes between the 2D-PC waveguides 14₁, 14₂.

As shown with the arrow R in FIG. 11B, the right ends of the even mode and the odd mode are respectively increased, as the radius r′ of air holes (holes) is enlarged. On the other hand, the coupling becomes strong since the refractive index difference between the 2D-PC waveguides 14₁, 14₂ becomes small, as the radius r of holes becomes small, as shown in FIG. 11B. For example, the coupling is stronger in the case of the radius of hole r′=0.2a, as compared with the case of r′=0.3a. However, also in this case since the frequency bands with a parallel dispersion curve is decreased if the coupling is too strong, there is a proper size thereof. In this case, as a result where the radius r of hole is small, the frequency bands on the whole are moved to the lower-frequency side.

### (Position Dependency of Dispersion Relationship of Holes Between Waveguides: Adjustment of Waveguide Bands)

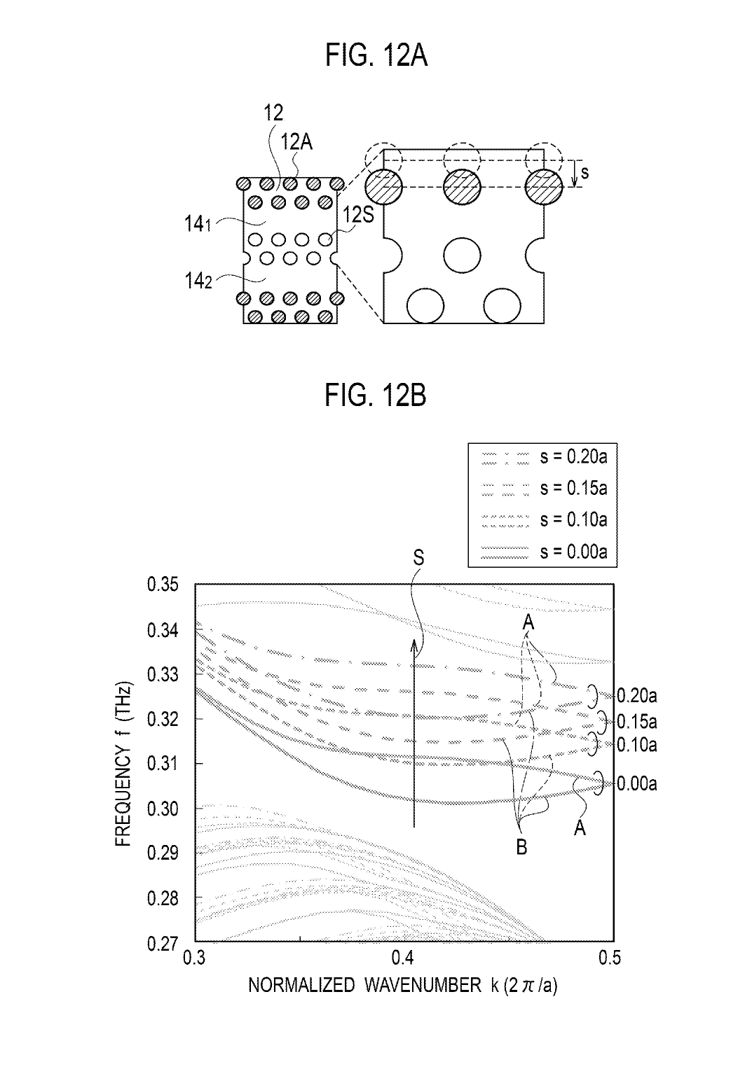

FIG. 12A shows an explanatory diagram of the waveguide width shift amount s in the case of inserting the lattice points in two rows between the 2D-PC waveguides 14₁, 14₂, and FIG. 12B shows a PB diagram in which the waveguide width shift amount s is used as a parameter.

In FIGS. 12A and 12B, the holes of lattice points 12A of the PC slab are shifted to a space side of inserting the holes 12S in two rows between the 2D-PC waveguides 14₁, 14₂ for only the waveguide width shift amount s, and thereby the width between the 2D-PC waveguides 14₁, 14₂ can be narrowed.

FIGS. 12A and 12B show an example of the space in which the lattice points in two rows are inserted between the 2D-PC waveguides 14₁, 14₂, and the waveguide width shift amount s is varied to 0.00a, 0.01a, or 0.15a. The curve A corresponds to the even mode and the curve B corresponds to the odd mode.

FIGS. 12A and 12B show an example of adjusting a waveguide width of the directional coupling unit 50. In this case, the lattice points in two rows are inserted between the 2D-PC waveguides 14₁, 14₂, and the radius r′ of hole is not adjusted.

As shown with the arrow S in FIG. 12B, there is proved an aspect that the waveguide bands are moved to high-frequency wave bands as the width of the 2D-PC waveguides 14₁, 14₂ becomes narrower (waveguide width shift amount s becomes larger). That is, if the waveguide width is varied so that the waveguide width is narrowed as shown with the arrow S in FIG. 12B, the whole mode is increased. As the whole holes of the lattice points 12A in the 2D-PC slab 12 is narrowed to inside so that the width of the line defect is narrowed, the whole mode is increased.

In the directional coupler 20 according to the embodiment, the waveguide band between the 2D-PC waveguides 14₁, 14₂ is adjustable by adjusting the waveguide width, and the hole diameter, period, and refractive index of the PC slab, etc. For example, if a semiconducting material which composing the PC slab 12 is GaₓIn₁₋ₓAs_{y}P_{1-y}, the refractive index can be changed by changing the composition ratios x and y.

As shown in FIGS. 11B and 12B, the width of the 2D-PC waveguides 14₁, 14₂ is formed to be narrowed, the radius r of the hole 12S between waveguides is enlarged, the period a is reduced, and the refractive index of materials of the 2D-PC slab 12 is reduced, and thereby the even mode and the odd mode of the PB diagram are moved to the higher-frequency side.

Conversely, the width of the 2D-PC waveguides 14₁, 14₂ is enlarged, the radius r′ of the hole 12S between waveguides is reduced, the period a is enlarged, and the refractive index of the materials of the 2D-PC slab 12 is enlarged, and thereby the even mode and the odd mode of the PB diagram are moved to the lower-frequency side. Accordingly, although the operational band of the directional coupler 20 may not be matched to the original operational band of the input waveguide, it is adjustable in the operational band of the input/output waveguide in the directional coupling unit 50 or the directional coupler 20 according to the directional coupler 20 according to the embodiment.

### (Example of Obtained PB Diagram)

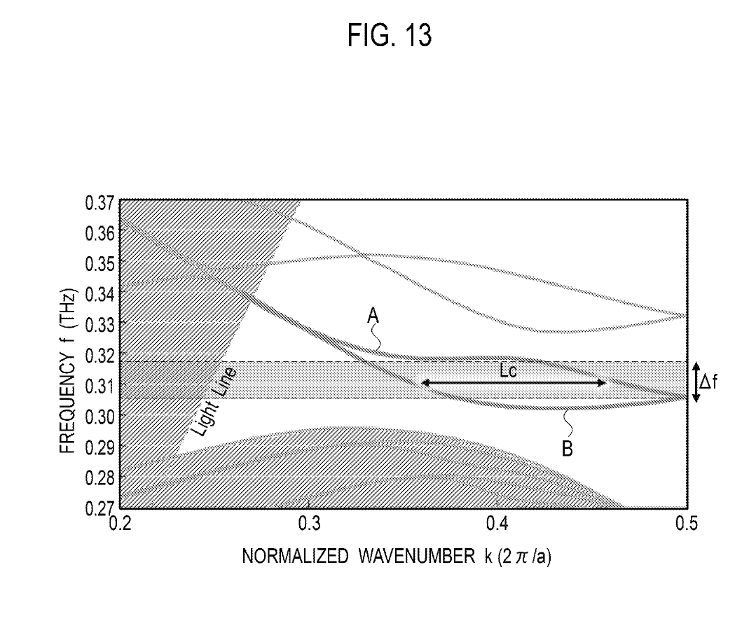

FIG. 13 shows examples of PB diagram obtained also on the basis of a result explained in FIGS. 6, 7, 9, and 10-12 in the directional coupler 20 according to the embodiment. A result of FIG. 13 is a band calculation result in the directional coupling unit 50 in the structure shown in FIG. 5. That is, the holes 12S between waveguides are arranged in two rows, the radius r′ of the holes 12S between waveguides is equal to 0.23a, and the waveguide width shift amount s is equal to 0.15a.

As shown in FIG. 13, a theoretical operational band of the frequency difference Δf is approximately 12 GHz, which is approximately 4% of the operational frequency f. A value of theoretical coupling length L_{C} is an approximately 4.2a, which is approximately equal to that of the operating wavelength. Accordingly, a band structure near ideal band structure can be obtained.

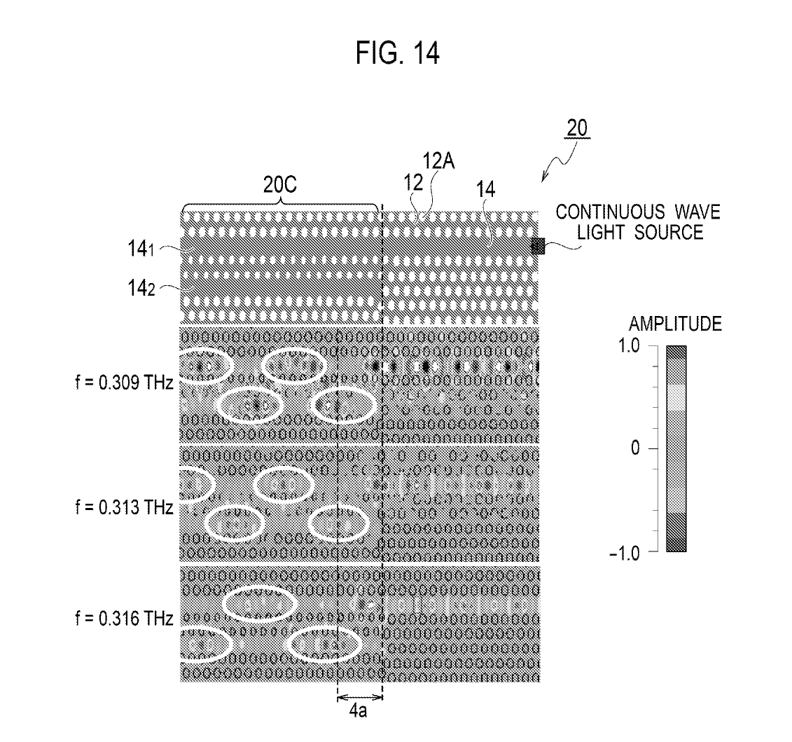

FIG. 14 shows a simulation result of confirming the coupling length L_{C} in the directional coupler 20 according to the embodiment. In this case, the holes 12S between the waveguides are arranged in two rows, the radius r of the holes 12S between waveguides is equal to 0.23a, and the waveguide width shift amount s thereof is equal to 0.15a.

As shown in FIG. 14, the THz wave is entering into 2D-PC waveguide 14 from a continuous wave light source, and then propagated with performing mode conversion of between 2D-PC waveguides 14₁, 14₂ with the even mode and the odd mode, in the coupling structure 20C of the directional coupler 20.

As shown in FIG. 14, the period (coupling length L_{C}) in which the mode conversion of between the 2D-PC waveguides 141, 142 is performed with the even mode and the odd mode is more nearly equal to four periods of the period a, as clearly from the simulation result at the frequency f=0.309 THz.

That is, it was confirmed that the even mode and the odd mode are converted at every 4 periods, 8 periods, 12 periods, 16 periods . . . to one another, and the coupling length L_{C} becomes constant with 4a at a band which is approximately 10 GHz, and the similar result as the band calculation result shown in FIG. 13 is obtained.

Moreover, as shown in FIG. 14, the coupling length L_{C} tends to become larger than 4a, as the frequency f increases from 0.309 THz to 0.313 THz, and to 0.316 THz. This is because the even mode and the odd mode of the PB diagram are moved to the higher-frequency side.

### (Transmission Characteristics: Simulation Result)

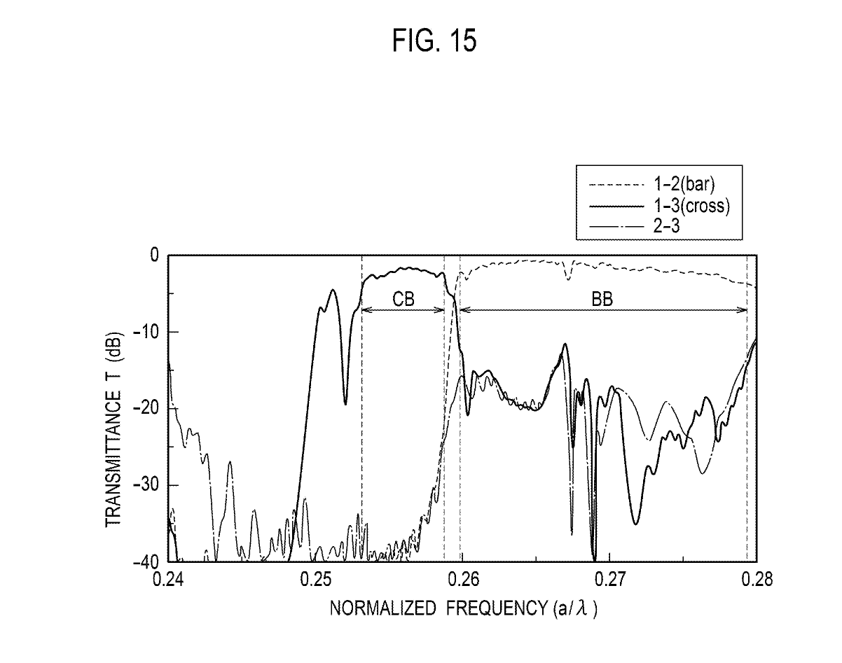

FIG. 15 shows a simulation result of transmission characteristics, in the directional coupler related to an embodiment. In FIG. 15, the curve shown with 1-2 (bar) indicates transmission characteristics of THz waves which propagate between the ports P1 and P2, the curve shown with 1-3 (cross) indicates transmission characteristics of THz waves which propagate between the ports P1 and P3, and the curve shown with 2-3 indicates transmission characteristics of THz waves which propagate between the ports P2 and P3. Moreover, BB indicates frequency ranges (bar band) where THz waves which propagate between the ports P1 and P2 showing satisfactory propagation characteristics. CB indicates frequency ranges (cross band) where THz waves which propagate between the ports P1 and P3 showing satisfactory propagation characteristics.

As shown in FIG. 15, the simulation result of transmission characteristics proves that signal separation ratio equal to or greater than 30 dB which is an operational band of 2.3% equal to or greater than 10 times of conventional operational bands can be realized, in the coupling length L_{C} of the approximately operating wavelength.

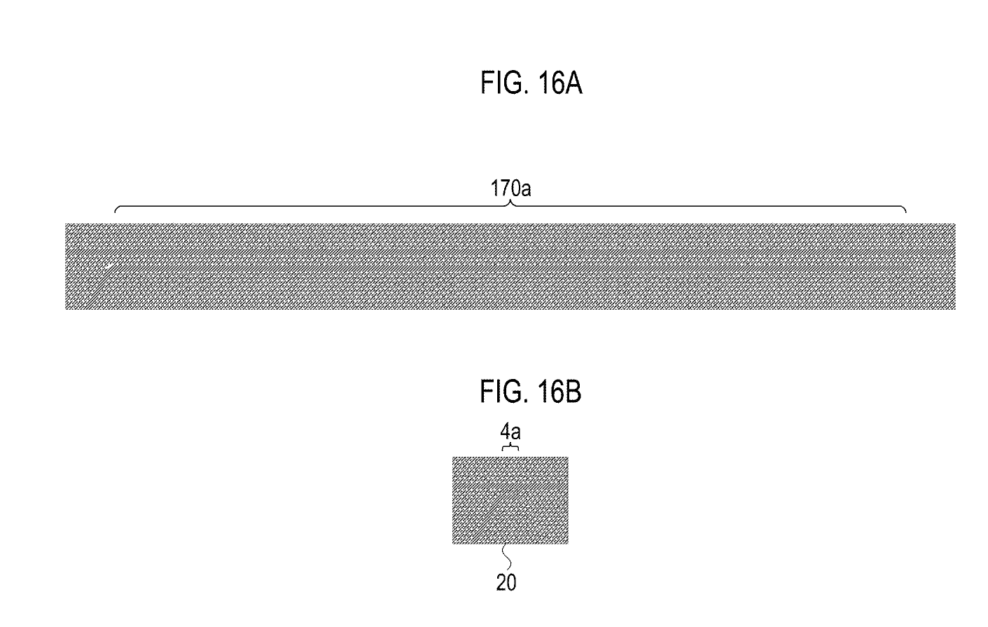

FIG. 16A shows a structure example of a directional coupler according to a comparative example, and FIG. 16B shows a structure example of the directional coupler according to the embodiment. The enlarged configuration shown in FIG. 16B has the same configuration as that shown in FIG. 5.

In the directional coupler according to the comparative example, as shown in FIG. 16A, the holes between waveguides are arranged in three rows in accordance with a simple design, and the size with a length 170a is required. Meanwhile, according to the directional coupler according to the embodiment, by adopting the above-mentioned design guide, operation with the size of length 4a can be realized, and microfabrication equal to or less than approximately 1/40 can realized. According to the directional coupler according to the embodiment, wider-band operation and improvement in the degree of signal separation can be realized.

### (Experimental Evaluation System)

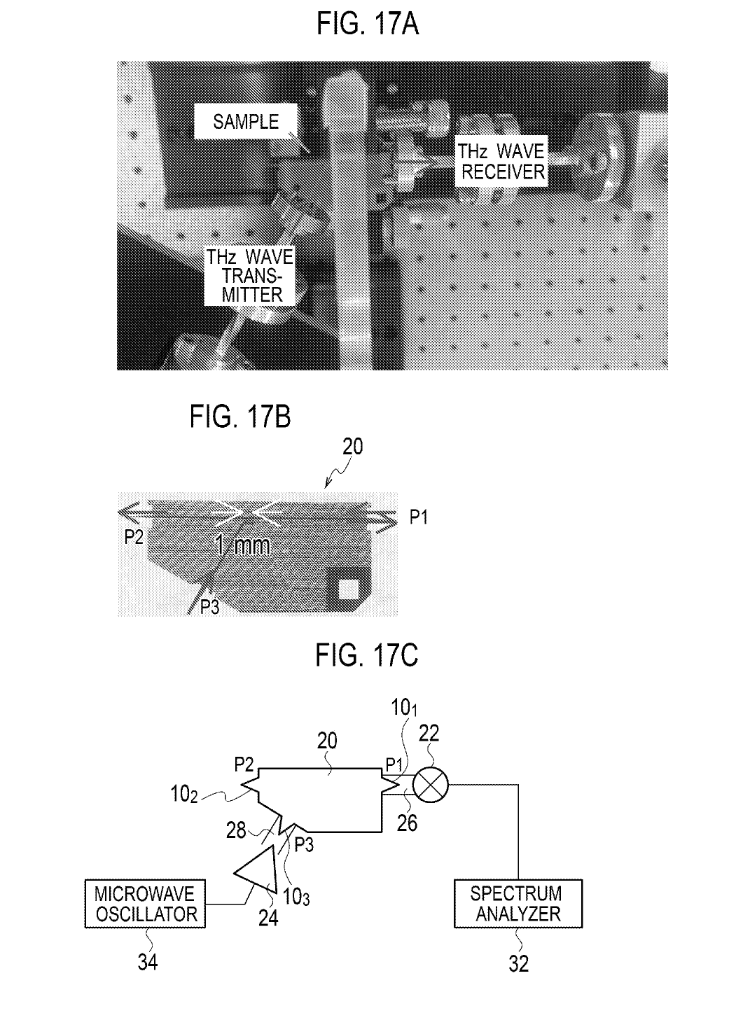

FIG. 17A shows a photograph of an experimental evaluation system for the purpose of an operation confirming of the directional coupler according to the embodiment, FIG. 17B shows a photograph sample of the directional coupler 20 applied to the experiment, and FIG. 17C shows a schematic block configuration of the experimental evaluation system corresponding to FIG. 17A.

The 2D-PC slab 12 which is a sample of the directional coupler 20 is composed of a silicon substrate in approximately 200 μm thick, and the period a of the lattice points 12A is approximately 240 μm.

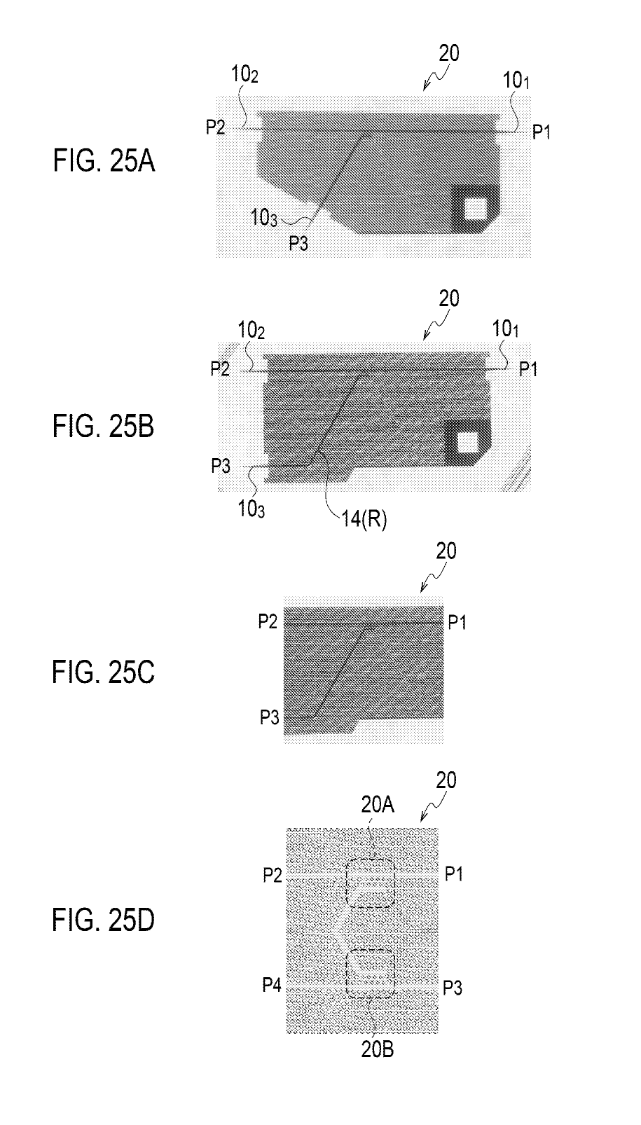

As shown in FIG. 17B, the ports P1, P2, P3 include an adiabatic mode converter arranged at an edge face of the 2D-PC slab 12 and composed of structure in which the 2D-PC waveguide extended, in order to improve bonding characteristics with a WR-3 waveguide etc. The adiabatic mode converter will be explained later in detail, with reference to FIG. 25.

As shown in FIGS. 17B and 17C, 0.28-0.38-THz continuous THz waves are generated using a millimeter-wave generator 34 and a 9 times multiplier 24, and then is made to incident into the PC waveguide of the directional coupler 20 from a port P3 via the WR-3 waveguide 28 and the adiabatic mode converter 10₃.

As shown in FIGS. 17B and 17C, an output from another port P1 of the directional coupler 20 is input into a THz wave mixer 22 via the WR-3 waveguide 26 and the adiabatic mode converter 10₁, and then is analyzed in a spectrum analyzer 32.

The transmittances with regard to the port P1 to port P2 (bar state), the port P1 to port P3 (crossed state), and the port P2 to port P3 are respectively measured by changing connection between the waveguide and the adiabatic mode converter. Examples of system of measurement of the port P1 to port P3 (crossed state) are shown in FIGS. 17A-17C.

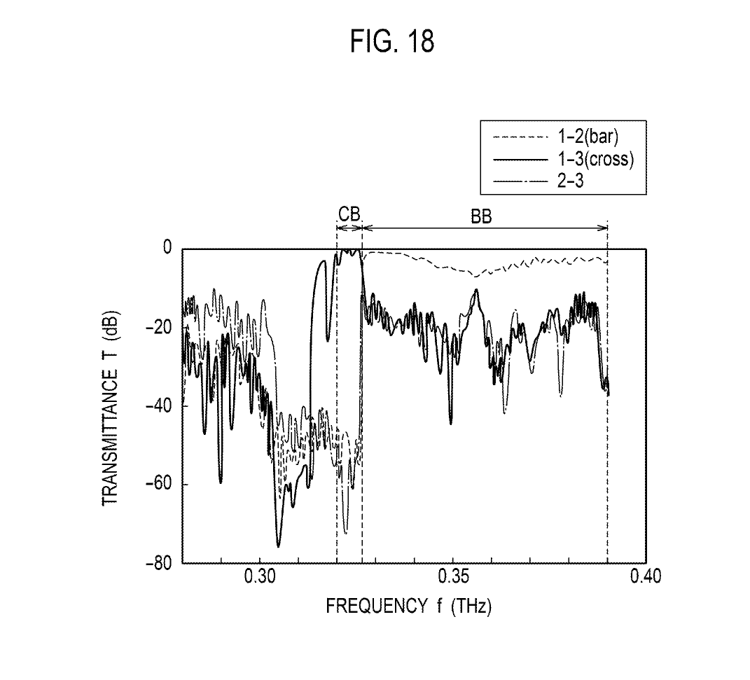

FIG. 18 shows an experimental result of transmission characteristics, in the directional coupler related to an embodiment. In FIG. 18, the curve shown with 1-2 (bar) indicates transmission characteristics of THz waves which propagate from the port P1 to the port P2, the curve shown with 1-3 (cross) indicates transmission characteristics of THz waves which propagate from the port P1 to the port P3, and the curve shown with 2-3 indicates transmission characteristics of THz waves which propagate from the port P2 to the port P3. Moreover, BB indicates frequency bands where the THz waves which propagate from the port P1 to the port P2 (bar state) show satisfactory propagation characteristics, and CB indicates frequency bands where the THz waves which propagate from the port P1 to the port P3 (crossed state) show satisfactory propagation characteristics.

In the experimental result shown in FIG. 18, a satisfactory matching with the simulation result of the transmission characteristics shown in FIG. 15 is obtained.

As clearly from the experimental result shown in FIG. 18, in the coupling length L_{C} of the wavelength approximately, there is obtained an operational band CB in the crossed state of which a band of −3 dB based on the peak transmittance is approximately 2.3% of the operational frequency equal to or greater than 10 times of the conventional bands. Moreover, it is proved that the signal separation ratio equal to or greater than 30 dB is realized between the crossed state and the bar state, in the THz wave bands.

### (Parallel Connection Configuration)

A configuration to connect the directional coupler in parallel may be adopted as a method of achieving further broader bandwidths.

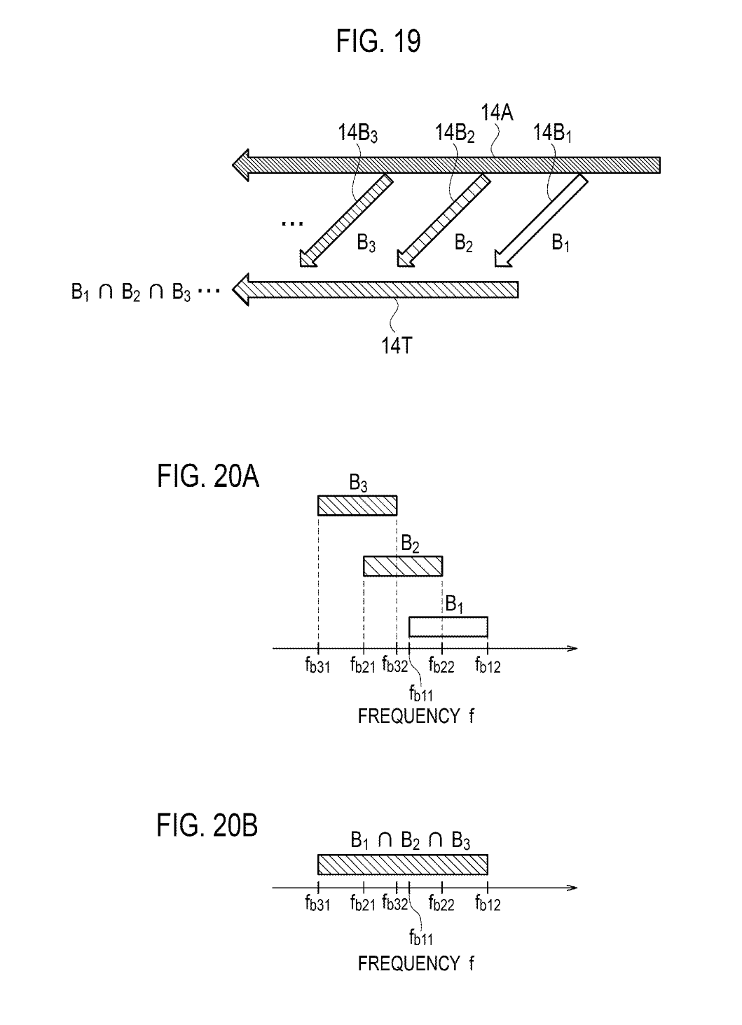

The configuration to connect the directional coupler according to the embodiment in parallel for the purpose of broader bandwidth is schematically illustrated as shown in FIG. 19. In FIG. 19, there is provided 2D-PC waveguides 14B1, 14B2, 14B3 . . . of crossed state branched from 2D-PC waveguides 14A of bar state, and a signal to which an operational band is extended can be propagated on the 2D-PC waveguide 14T which integrates these waveguides. That is, signals respectively having operational bands B1, B2, B3 . . . propagate on the 2D-PC waveguide 14B1, 14B2, 14B3 . . . of the crossed state, and signals having extended operational bands B1∩B2∩B3∩ . . . propagates on the 2D-PC waveguide 14T.

Moreover, FIG. 20A is a schematic explanatory diagram of broader bandwidths of the operational bands realized by connecting directional couplers in parallel, and is a schematic diagram showing operational bands B3, B2, B1 overlapped one another, in the directional coupler according to the embodiment. FIG. 20B shows a schematic diagram of broadened operational bands B3∩B2∩B1.

As shown in FIG. 20A, the operational band B3 has a band between frequencies f_{b31} and f_{b32}, the operational band B2 has a band between frequencies f_{b21} and f_{b22}, and the operational band B1 has a band between frequencies f_{b11} and f_{b12}. Accordingly, the extended operational bands B1∩B2∩B3 have bands between the frequencies f_{b31} and f_{b12}.

Since the operational frequency f is determined with the period a of PC and the waveguide width, the further broader bandwidth can be achieved by forming the parallel connection structure in which the period a or the waveguide width is changed.

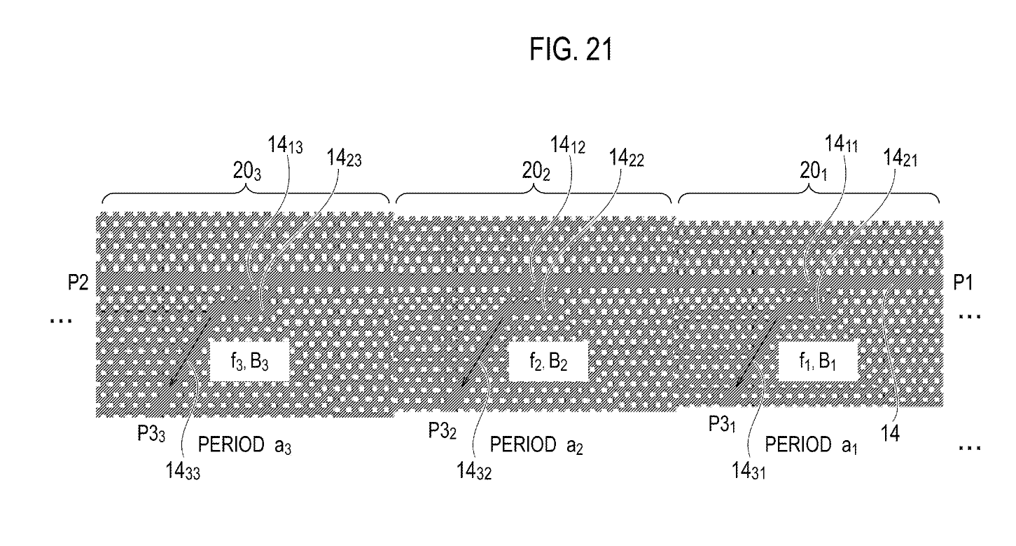

FIG. 21 shows a planar pattern configuration of structure of connecting three stages of the directional couplers in parallel for the purpose of broader bandwidths in the directional coupler according to the embodiment. In FIG. 21, the directional couplers 20₁, 20₂, 20₃ are connected thereto in parallel. The periods of lattice points 12A in the 2D-PC slab 12 composing the directional couplers 20₁, 20₂, 20₃ are respectively a₁, a₂, a₃.

In the directional couplers 20₁, 20₂, 20₃, there are obtained signals respectively having the operational frequency f₁ and operational band B₁, the operational frequency f₂ and operational band B₂, and the operational frequency f₃ and operational band B₃ from the ports P3₁, P3₂, P3₃, via the 2D-PC waveguides 14₃₁, 14₃₂, 14₃₃ in the crossed state branched from the 2D-PC waveguides 14₁₁, 14₁₂, 14₁₃ in the bar state. The directional couplers 20₁, 20₂, 20₃ are composed as well as the above-mentioned directional coupler 20 according to the embodiment.

In this case, the mode coupling of the 2D-PC waveguides 14₁₁, 14₂₁ is realized, and the lattice points between waveguides arranged in two rows are arranged between the 2D-PC waveguides 14₁₁, 14₂₁. The radius r′ of holes of the lattice points between waveguides is set as 0.23a₁, for example, so that the propagation constant of the even mode and the odd mode may become constant over the broader frequency ranges.

In order to match the 2D-PC waveguide 14 to the operational band at the side of port P1 from the directional coupling unit, the width of the 2D-PC waveguide 14₂₁ is formed to be narrowed compared with the width formed with the line defect of lattice point so that the whole dispersion curve of the directional coupling unit may be moved to the higher-frequency side. For example, the width of the 2D-PC waveguide 14₂₁ is formed to be narrowed for 0.15 time of the period a₁.

In order to increase the degree of signal separation in the bar state between the port P1 and the port P2, and in the crossed state between the port P1 and the port P3₁, the width of the 2D-PC waveguide 14₁₁ at the side of the port P2 from the directional coupling unit is formed to be narrowed. For example, the width of the 2D-PC waveguide 14₁₁ is formed to be narrowed for 0.15 time of the period a₁.

Similarly, the mode coupling of the 2D-PC waveguides 14₁₂, 14₂₂ is realized, and the lattice points between waveguides arranged in two rows are arranged between the 2D-PC waveguides 14₁₂ and 14₂₂. The radius r′ of holes of the lattice points between waveguides is set as 0.23a₂, for example, so that the propagation constant of the even mode and the odd mode may become constant over the broader frequency ranges.

In order to match the 2D-PC waveguide 14₁₂ to the operational band at the side of port P1 from the directional coupling unit, the width of the 2D-PC waveguide 14₂₂ is formed to be narrowed compared with the width formed with the line defect of lattice point so that the whole dispersion curve of the directional coupling unit may be moved to the higher-frequency side. For example, the width of the 2D-PC waveguide 14₂₂ is formed to be narrowed for 0.15 time of the period a₂.

Moreover, in order to increase the degree of signal separation in the bar state between the port P1 and the port P2, and in the crossed state between the port P1 and the port P32, the width of the 2D-PC waveguide 1412 at the side of the port P2 from the directional coupling unit is formed to be narrowed. For example, the width of the 2D-PC waveguide 14₁₂ is formed to be narrowed for 0.15 time of the period a₂.

Similarly, the mode coupling of the 2D-PC waveguides 14₁₃, 14₂₃ is realized, and the lattice points between waveguides arranged in two rows are arranged between the 2D-PC waveguides 14₁₃ and 14₂₃. The radius r′ of holes of the lattice points between waveguides is set as 0.23a₃, for example, so that the propagation constant of the even mode and the odd mode may become constant over the broader frequency ranges.

In order to match the 2D-PC waveguide 14₁₃ to the operational band at the side of port P1 from the directional coupling unit, the width of the 2D-PC waveguide 14₂₃ is formed to be narrowed compared with the width formed with the line defect of lattice point so that the whole dispersion curve of the directional coupling unit may be moved to the higher-frequency side. For example, the width of the 2D-PC waveguide 14₂₃ is formed to be narrowed for 0.3 time of the period a₃.

Moreover, in order to increase the degree of signal separation in the bar state between the port P1 and the port P2, and in the crossed state between the port P1 and the port P3₃, the width of the 2D-PC waveguide 14₁₃ at the side of the port P2 from the directional coupling unit is formed to be narrowed. For example, the width of the 2D-PC waveguide 14₁₃ is formed to be narrowed for 0.15 time of the period a₃ of the lattice points.

In the directional couplers 201, 202, 203 connected thereto in parallel, the following relationships are realized between the operational frequencies f1, f2, f3 and the periods a1, a2, a3 of the lattice points:

f₂=(a₁/a₂)f₁,f₃=(a₂/a₃)f₂ (1)

B₂=(f₂/f₁)B₁,B₃=(f₃/f₂)B₂ (2)

Also in the directional couplers in multi stage connected in parallel, the similar relationships as the equations (1) and (2) are realized between adjacent directional couplers.

In the directional coupler according to the embodiment, as mentioned above, due to the configuration of the directional couplers 20₁, 20₂, 20₃ in three-stage connected in parallel, the operational bands B₁, B₂ B₃ are set up just to be connected on the frequency characteristics on the relationship between the operational band B and the operational frequency f, or are set up to be respectively larger than 0% and smaller than 100%, and thereby the operational band can be enlarged by connecting in parallel.

### (Illustrative Example of Parallelized Structure)

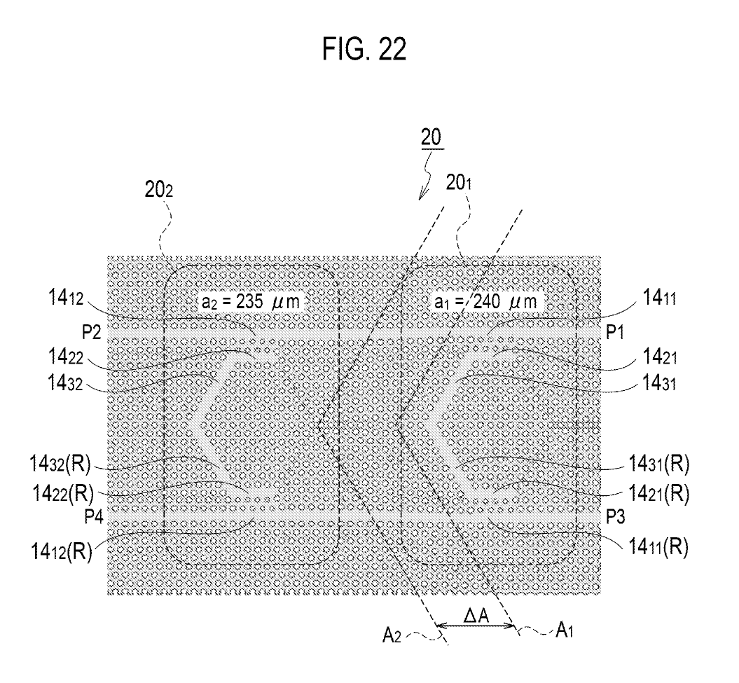

FIG. 22 shows a planar pattern configuration of structure of connecting two stages of the directional couplers 20₁, 20₂ in parallel, in the directional coupler according to the embodiment. In the configuration of FIG. 22, a point of providing the 2D-PC waveguides 14₃₁, 14₃₂ in the branched crossed state with respect to the 2D-PC waveguides 14₁₁, 14₁₂ in the bar state between the port P1 and the port P2 is the same as that of the above-mentioned embodiment. In the configuration of FIG. 22, the 2D-PC waveguides 14₃₁(R), 14₃₂ (R) in the branched crossed state is provided with respect to the 2D-PC waveguides 14₁₁(R), 14₁₂(R) in the bar structure between the port P3 and the port P4.

The periods of lattice points 12A in the 2D-PC slab 12 composing the directional couplers 20₁, 20₂ are respectively a₁, a₂. In this case, the periods a₁ and a₂ are respectively approximately 240 μm and approximately 235 μm, as a detailed numerical example, for example. Moreover, in order to reduce an influence of reflection in a junction interface between the directional couplers 20₁, 20₂, as shown in FIG. 22, in a transition region ΔA sandwiched with border lines A₁, A₂, the period is gradually varied for 0.5 μm, for example. The influence of reflection in the interface between the period a₁ and the period a₂ of lattice points of directional couplers 20₁, 20₂ can be reduced by forming such a transition region ΔA.

In the directional couplers 20₁, 20₂, the 2D-PC waveguides 14₃₁, 14₃₂ in the crossed state are branched from the 2D-PC waveguides 14₁₁, 14₁₂ in the bar state between the port P1 and the port P2, and the 2D-PC waveguides 14₃₁(R), 14₃₂(R) in the crossed state are branched from the 2D-PC waveguides 14₁₁(R), 14₁₂(R) in the bar state between the port P3 and the port P4. The 2D-PC waveguides 14₃₁, 14₃₂ in the crossed state are coupled with the 2D-PC waveguides 14₃₁(R), 14₃₂(R) in the crossed state at a center portion, and the structure shown in FIG. 22 is provided with a configuration to be folded upward and downward.

In this case, the mode coupling of the 2D-PC waveguides 14₁₁, 14₂₁ is realized, and the lattice points between waveguides arranged in two rows are arranged between the 2D-PC waveguides 14₁₁, 14₂₁. The radius r′ of holes of the lattice points between waveguides is set as 0.23a₁, for example, so that the propagation constant of the even mode and the odd mode may become constant over the broader frequency ranges.

In order to match the 2D-PC waveguide 14₁₁ to the operational band at the side of port P1 from the directional coupling unit, the width of the 2D-PC waveguide 14₂₁ is narrowed compared with the width formed with the line defect of lattice point so that the whole dispersion curve of the directional coupling unit may be moved to the higher-frequency side. For example, the width of the 2D-PC waveguide 14₂₁ is formed to be narrowed for 0.15 time of the period a₁.

Moreover, in order to increase the degree of signal separation between the bar state and the crossed state, the width of the 2D-PC waveguide 14₁₁ at the side of the second port P2 from the directional coupling unit is formed to be narrowed. For example, the width of the 2D-PC waveguide 14₁₁ is formed to be narrowed for 0.15 time of the period a₁.

Similarly, the mode coupling of the 2D-PC waveguides 14₁₂, 14₂₂ is realized, and the lattice points between waveguides arranged in two rows are arranged between the 2D-PC waveguides 14₁₂ and 14₂₂. The radius r′ of holes of the lattice points between waveguides is set as 0.23a₂, for example, so that the propagation constant of the even mode and the odd mode may become constant over the broader frequency ranges.

In order to match the 2D-PC waveguide 14₁₂ to the operational band at the side of the first port P1 from the directional coupling unit, the width of the 2D-PC waveguide 14₂₂ is formed to be narrowed compared with the width formed with the line defect of lattice point so that the whole dispersion curve of the directional coupling unit may be moved to the higher-frequency side. For example, the width of the 2D-PC waveguide 14₂₂ is formed to be narrowed for 0.15 time of the period a2.

Moreover, in order to increase the degree of signal separation between the bar state and the crossed state, the width of the 2D-PC waveguide 14₁₂ at the side of the second port P2 from the directional coupling unit is formed to be narrowed. For example, the width of the 2D-PC waveguide 14₁₂ is formed to be narrowed for 0.15 time of the period a₂.

Similarly, the mode coupling of the 2D-PC waveguides 14₁₁(R), 14₂₁(R) is realized, and the lattice points between waveguides arranged in two rows are arranged between the 2D-PC waveguides 14₁₁(R), 14₂₁(R). The radius r′ of holes of the lattice points between waveguides is set as 0.23a₁, for example, so that the propagation constant of the even mode and the odd mode may become constant over the broader frequency ranges.

In order to match the 2D-PC waveguide 1411 to the operational band at the side of the port P3 from the directional coupling unit, the width of the 2D-PC waveguide 14₂₁(R) is formed to be narrowed compared with the width formed with the line defect of lattice point so that the whole dispersion curve of the directional coupler may be moved to the higher-frequency side. For example, the width of the 2D-PC waveguide 14₂₁(R) is formed to be narrowed for 0.15 time of the period a₁.

Moreover, in order to increase the degree of signal separation between the bar state and the crossed state, the width of the 2D-PC waveguide 14₁₁(R) at the side of the port P4 from the directional coupling unit is formed to be narrowed. For example, the width of the 2D-PC waveguide 14₁₁(R) is formed to be narrowed for 0.15 time of the period a₁.

Similarly, the mode coupling of the 2D-PC waveguides 14₁₂(R), 14₂₂(R) is realized, and the lattice points between waveguides arranged in two rows are arranged between the 2D-PC waveguides 14₁₂(R), 14₂₂(R). The radius r of holes of the lattice points between waveguides is set as 0.23a₂, for example, so that the propagation constant of the even mode and the odd mode may become constant over the broader frequency ranges.

In order to match the 2D-PC waveguide 14₁₁(R) to the operational band from the directional coupling unit, the width of the 2D-PC waveguide 14₂₂(R) is formed to be narrowed compared with the width formed with the line defect of lattice point so that the whole dispersion curve of the directional coupling unit may be moved to the higher-frequency side. For example, the width of the 2D-PC waveguide 14₂₂(R) is formed to be narrowed for 0.15 time of the period a₂.

Moreover, in order to increase the degree of signal separation between the bar state and the crossed state, the width of the 2D-PC waveguide 14₁₂(R) at the side of the port P4 from the directional coupling unit is formed to be narrowed. For example, the width of the 2D-PC waveguide 14₁₂(R) is formed to be narrowed for 0.15 time of the period a₂.

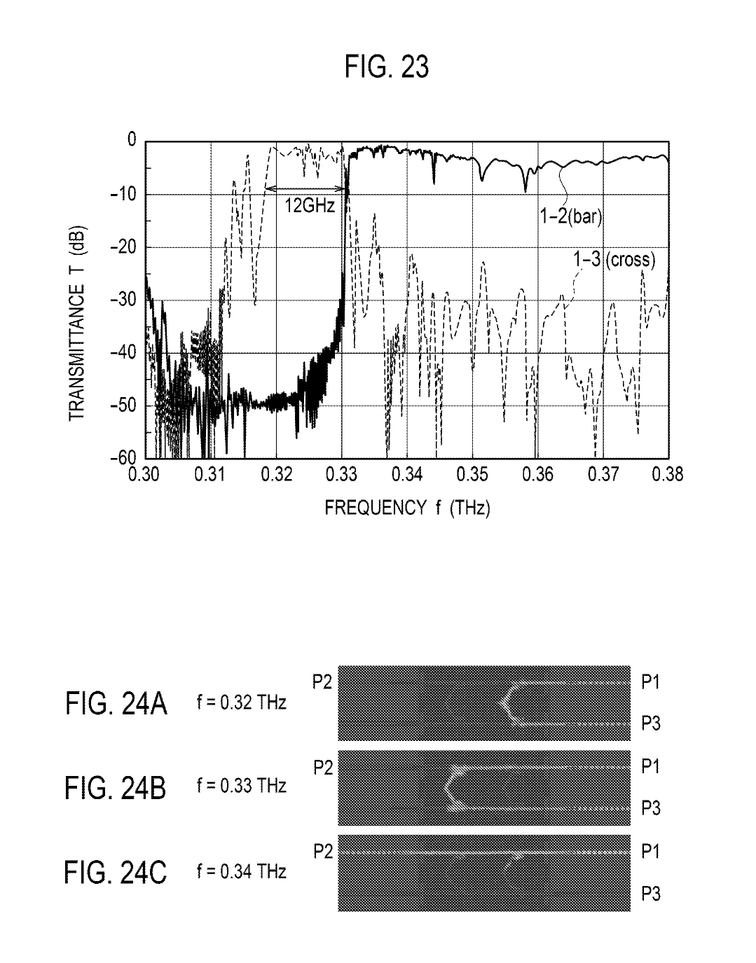

FIG. 23 shows a simulation result of frequency characteristics (transmission spectrum) of transmittance T (dB), in the directional couplers according to the embodiment having structure of being connected in two stages in parallel corresponding to that shown in FIG. 22.

As clearly from a simulation result of the transmission spectrum, −10 dB band can be extended to approximately 12 GHz by parallelizing.

Moreover, FIG. 24A shows a simulation result of an electromagnetic field distribution from port P1 to port P3 (cross) state in the case of frequency f=0.32 THz. FIG. 24B shows a simulation result of an electromagnetic field distribution from port P1 to port P3 (cross) state in the case of frequency f=0.33 THz. FIG. 24C shows a simulation result of an electromagnetic field distribution from port P1 to port P2 (bar) state in the case of frequency f=0.34 THz. The operation in the crossed state and the bar state in each frequency was confirmed from the above-mentioned electromagnetic field distribution.

It is proved that, in the case of the frequency f=0.32 THz, as shown in FIG. 24A, the propagation mode from the port P1 to the port P3 (cross) state is remarkable, as compared with the propagation mode from the port P1 to the port P2 (bar) state.

It is proved that, in the case of the frequency f=0.33 THz, as shown in FIG. 24B, the propagation mode from the port P1 to the port P3 (cross) state is remarkable, as compared with the propagation mode from the port P1 to the port P2 (bar) state. In particular, in the case of frequency f=0.33 THz, the propagation mode from the port P1 to the port P3 (cross) state via the directional coupler 20₂ is remarkable.

It is proved that, in the case of the frequency f=0.34 THz, as shown in FIG. 24V, the propagation mode from the port P1 to the port P2 (bar) state is remarkable, as compared with the propagation mode from the port P1 to the port P3 (cross) state.

### Other Structural Examples

### Modified Example 1

FIG. 25A shows a structural example of a directional coupler 20 according to a modified example 1, in another structural example of the directional coupler according to the embodiment. In this case, the lower right rectangle is merely a mark for indicating a sample, and therefore is unrelated to the constituent features of device. The same applies hereafter.

As shown in FIG. 25A, the directional coupler 20 according to the modified example 1 of the embodiment includes adiabatic mode converters 10₁, 10₂, 10₃ arranged at an edge face of the 2D-PC slab in order to improve the bonding characteristics with the WR-3 waveguide etc., in the port P1, the port P2, and the port P3, the adiabatic mode converters 101, 102, 103 to which the 2D-PC waveguide is extended. Other structures are the same as those of the directional coupler according to the embodiment.

The adiabatic mode converters 10₁, 10₂, 10₃ are provided with a taper shape so that a tip part thereof becomes thin as being separated from the edge face of the 2D-PC slab 12, in the planar view of the 2D-PC slab 12. In this case, the side surface of the taper shape may include an inclined surface. Moreover, the side surface of the taper shape may include a curved surface. Moreover, the side surface of the taper shape may include a stepped surface.

Moreover, the adiabatic mode converters 10₁, 10₂, 10₃ may include a conical shape so that the tip part becomes thinner as being distanced from the edge face of 2D-PC slab 12.

Moreover, the adiabatic mode converters 10₁, 10₂, 10₃ may include a quadrangular pyramid shape so that the tip part becomes thinner as being distanced from the edge face of 2D-PC slab 12.

Moreover, the adiabatic mode converters 10₁, 10₂, 10₃ may include a wedge-like shape so that the tip part becomes thinner as being distanced from the edge face of 2D-PC slab 12.

Moreover, the adiabatic mode converters 10₁, 10₂, 10₃ may include a wedge-like shape so that the tip part becomes thinner as being distanced from the edge face of 2D-PC slab 12.

Moreover, the adiabatic mode converters 10₁, 10₂, 10₃ may include a stairs-like shape so that the tip part becomes thinner as being distanced from the edge face of 2D-PC slab 12.

Moreover, the adiabatic mode converters 10₁, 10₂, 10₃ may be protected with a resin layer.

The adiabatic mode converters 10₁, 10₂, 10₃ can be inserted into the waveguide line. In this case, a waveguide flange arranged at an edge face of the 2D-PC slab 12 may be in contact with the edge face. The waveguide flange arranged at the edge face of the 2D-PC slab 12 may be separated from the edge face.

Furthermore, the edge face of the 2D-PC slab 12, where the adiabatic mode converters 10₁, 10₂, 10₃ are arranged, includes a gap between the waveguide flanges arranged at the edge face of the 2D-PC slab 12, in a peripheral part of the adiabatic mode converters 10₁, 10₂, 10₃, and may be separated from the waveguide flange. If there is such a gap, since the waveguide flange is arranged so as to be separated from the edge face of the 2D-PC slab 12, a surface mode of the THz input wave can be controlled.

In particular, in order to control the surface mode, it is preferable to set the gap distance W_{G}>wavelength/3, where W_{G} is a gap distance.

Although the detailed structure is omitted, the edge face of the 2D-PC slab 12 where the adiabatic mode converters 10₁, 10₂, 10₃ are arranged, includes a gap between the waveguide flanges arranged at the edge face of the 2D-PC slab 12, in the peripheral part of the adiabatic mode converters 10₂, 10₂, 10₃, in an example shown in FIG. 25A.

### Modified Example 2

FIG. 25B shows a structural example of a directional coupler 20 according to a modified example 2, in another structural example of the directional coupler according to the embodiment.

As shown in FIG. 25A, a structural example of directly outputting to the port P3 is shown in the directional coupler 20 according to the modified example 1. On the other hand, as shown in FIG. 25B, the directional coupler 20 applied to the modified example 2 includes a bending waveguide 14(R), and the output to the port P3 is possible via this bending waveguide 14(R). Other structures are the same as those of the directional coupler according to the embodiment.

### Modified Example 3

FIG. 25C shows a structural example of a directional coupler 20 according to a modified example 3, in another structural example of the directional coupler according to the embodiment.

The directional coupler 20 according to the modified example 1 includes the adiabatic mode converters 10₁, 10₂, 10₃ composed of the tapered structure to which the 2D-PC waveguide extended, in the ports P1, P2, P3, as shown in FIG. 25A. On the other hand, the directional coupler 20 according to the modified example 3 does not include the adiabatic mode converters 10₁, 10₂, 10₃, as shown in FIG. 25C. Thus, such a structure not having in particular the adiabatic mode converters 10₁, 10₂, 10₃ in the ports P1, P2, P3 is also realized. Other structures are the same as those of the directional coupler according to the embodiment.

### Modified Example 4

FIG. 25D shows a structural example of a directional coupler 20 according to a modified example 4, in another structural example of the directional coupler according to the embodiment.

As shown in FIG. 25D, the directional coupler 20 according to the modified example 4 includes two directional couplers 20A, 20B and four ports P1, P2, P3, P4. The structural example of the directional coupler 20 according to the modified example 4 is the same as that of the configuration of the directional coupler 20₁ at the first stage portion in the directional coupler according to the embodiment having two-stage parallelizing structure shown in FIG. 22. Other structures are the same as those of the directional coupler according to the embodiment.

In the multiplexer and demultiplexer 30 to which the directional couplers according to modified examples 1-4 of the embodiment is applied, there is realized a method of entering focused light with a lens into the edge face as an input/output. Alternatively, a method of outputting and inputting from free space via the input/output interface 60 composed of the PC is also realized as well as FIG. 1. In this case, if the input/output interface 60 is composed of the PC, it can be composed of a grating coupler, in the case of one-dimensional structure. Moreover, 2D structure is also realized. As an input/output, a method of integrating a light source or a detector can also be composed as well as FIG. 1.

### (Periodic Structure and Band Structure of Lattice Points)

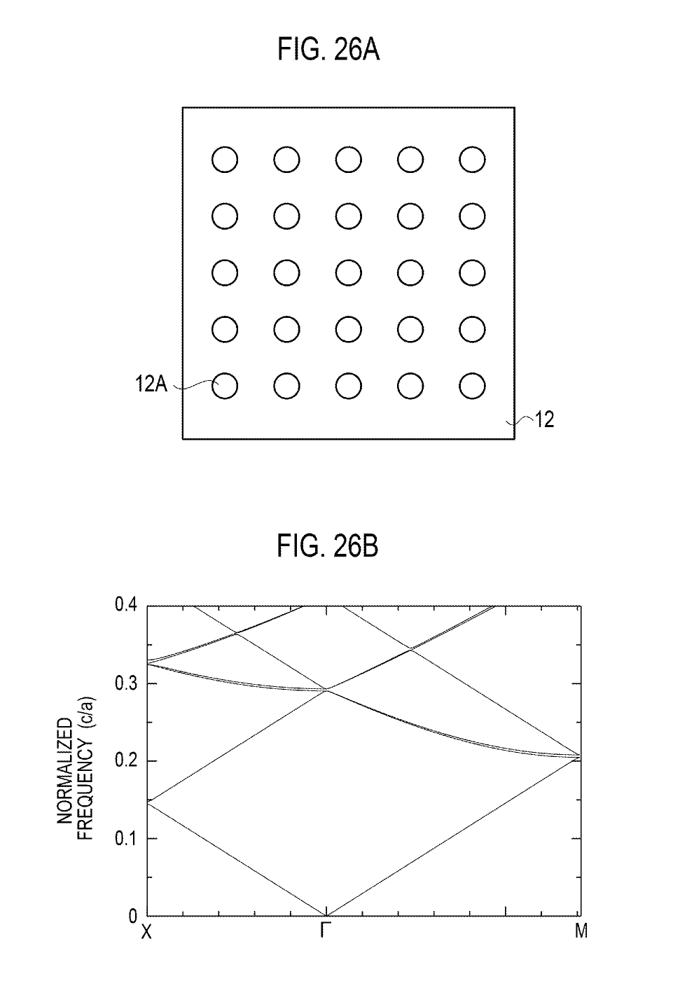

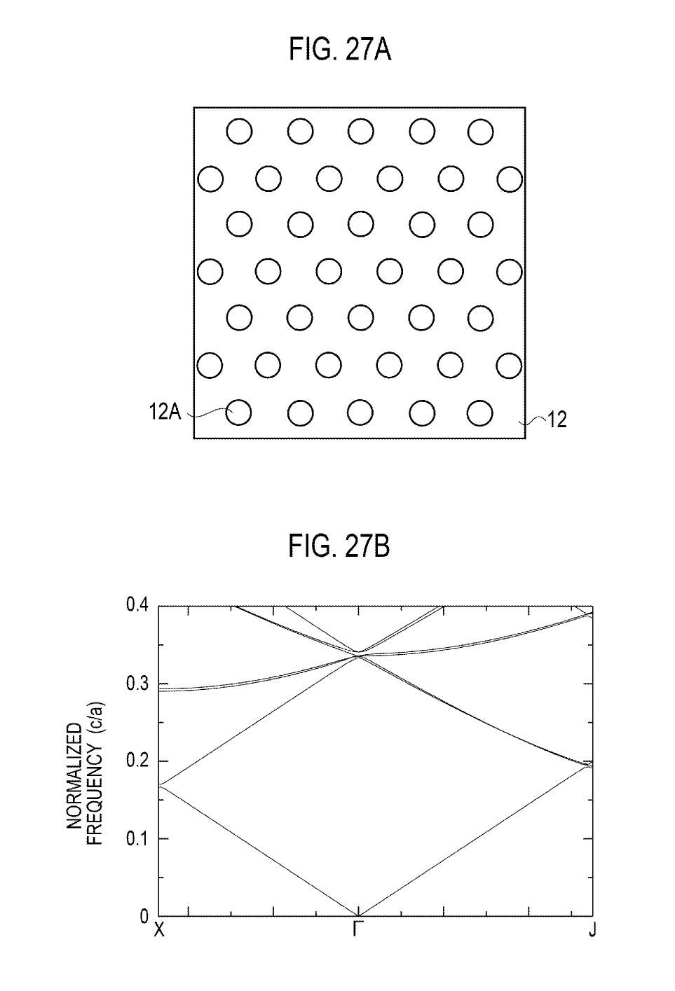

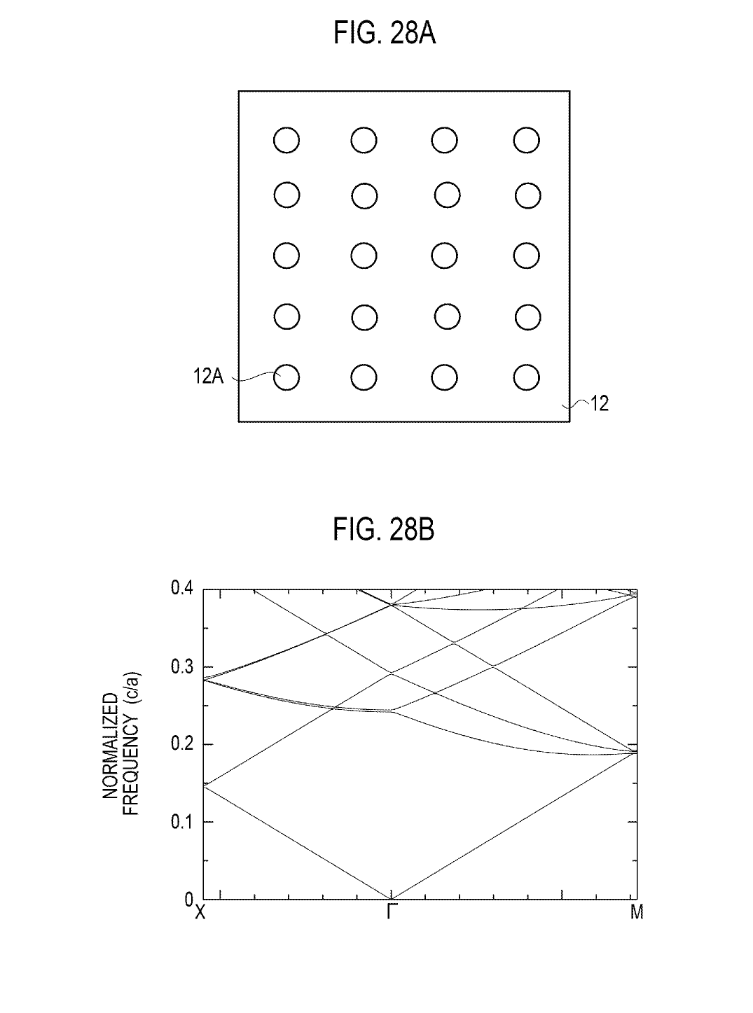

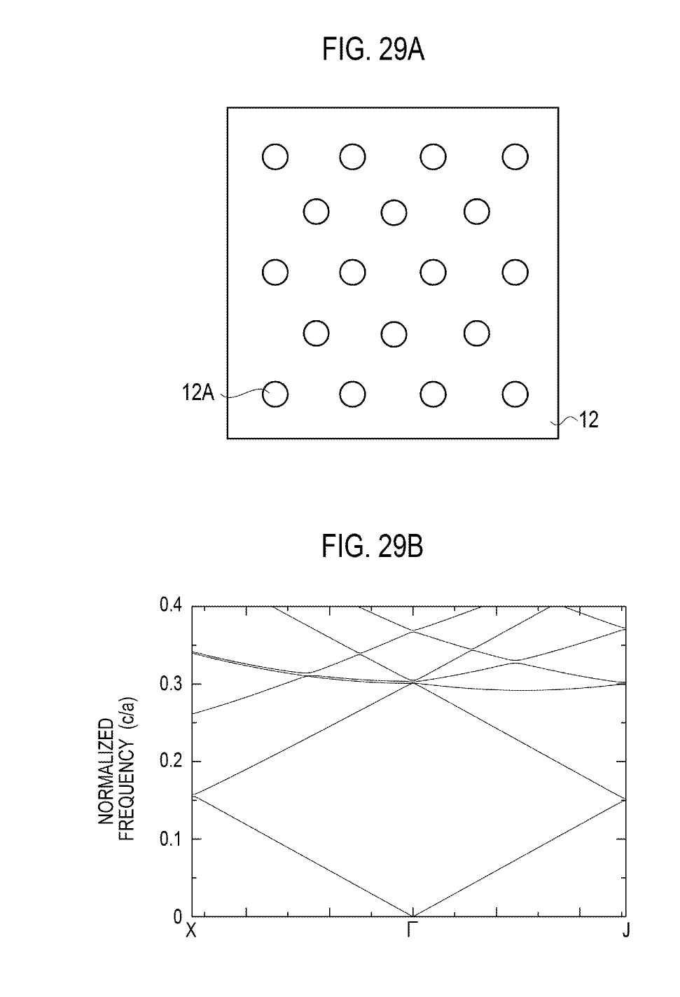

In the 2D-PC slab 12 applicable to the directional coupler 20 and the multiplexer and demultiplexer 30 according to the embodiment, FIGS. 26A, 27A, 28A, and 29A show respectively examples of arrangement of the square lattice, triangular lattice, rectangular lattice, and rhombic lattice (face-centered rectangle lattice) which are periodic structures of the lattice points 12A. FIGS. 26B, 27B, 28B, and 29B show respectively corresponding band structures of 2D-PC slab 12.

The lattice point for forming resonant-state may be arranged in any one selected from the group consisting of a square lattice, a rectangular lattice, a face-centered rectangle lattice, and a triangular lattice.

Moreover, the lattice point 12A is arranged in a square lattice or a rectangular lattice, and can resonate the electromagnetic wave in a Γ point (gamma point), an X point, or an M point in the PB structure of the 2D-PC slab 12, in the PC slab plane.

Moreover, the lattice point 12A is arranged in a face-centered rectangle lattice or a triangular lattice, and can resonate the electromagnetic wave in a Γ point, an X point, or an J point in the PB structure of the 2D-PC slab 12, in the PC slab plane.

Moreover, the lattice points 12A may be provided with any one of the polygonal shape, circular shape, oval shape, or ellipse shape.

As mentioned above, according to the embodiment, there can be provided the directional coupler which has the wide-band and high degree of signal separation and can be miniaturized, used for optical waves, THz waves, or millimeter waves, and the multiplexer and demultiplexer to which such a directional coupler is applied.

In particular, since the directional coupler of the present invention can be miniaturized, it is applicable to broad applicable fields, e.g. filters, switches, power monitors, distribution of power, etc., besides the multiplexer/demultiplexer.

### Other Embodiments

As explained above, the embodiment has been described, as a disclosure including associated description and drawings to be construed as illustrative, not restrictive. This disclosure makes clear a variety of alternative embodiments, working examples, and operational techniques for those skilled in the art.

Such being the case, the embodiment covers a variety of embodiments, whether described or not.

What is claimed is:

1. A directional coupler comprising:
a two dimensional photonic crystal slab;
lattice points periodically arranged in the two dimensional photonic crystal slab, the lattice points configured to diffract optical waves, terahertz waves, or millimeter waves in photonic bandgap frequencies in photonic band structure of the two dimensional photonic crystal slab in order to prohibit existence in a plane of the two dimensional photonic crystal slab;
a first two dimensional photonic crystal waveguide disposed in the two dimensional photonic crystal slab and formed with a line defect of the lattice points;
a second two dimensional photonic crystal waveguide formed of a line defect of the lattice point in the two dimensional photonic crystal slab, mode coupling of the second two dimensional photonic crystal waveguide being realized to the first two dimensional photonic crystal waveguide; and
a directional coupling unit disposed between the first two dimensional photonic crystal waveguide and the second two dimensional photonic crystal waveguide, the directional coupling unit including lattice points between waveguides, the size of the lattice points between waveguides is smaller than that of the lattice point.

2. The directional coupler according to claim 1, wherein
the second two dimensional photonic crystal waveguide is disposed in parallel to the first two dimensional photonic crystal waveguide.

3. The directional coupler according to claim 1, wherein
the lattice points between waveguides are arranged in two rows.

4. The directional coupler according to claim 1, wherein
the first two dimensional photonic crystal waveguide comprises a first port and a second port.

5. The directional coupler according to claim 4, wherein
in order to match the first two dimensional photonic crystal waveguide to an operational band at a side of the first port from the directional coupling unit, a width of the second two dimensional photonic crystal waveguide is formed to be narrowed as compared with the width formed of the line defect of the lattice point so that a whole dispersion curve of the directional coupling unit is moved to a higher-frequency side.

6. The directional coupler according to claim 5, further comprising:
a third two dimensional photonic crystal waveguide formed of the line defect of the lattice point in the two dimensional photonic crystal slab, the third two dimensional photonic crystal waveguide being arranged to be crossed with the second two dimensional photonic crystal waveguide, the third two dimensional photonic crystal waveguide comprising a third port, wherein
in order to increase a degree of signal separation in a bar state between the first port and the second port and a crossed state between the first port and the third port, a width of the first two dimensional photonic crystal waveguide at a side of the second port is formed to be narrowed as compared with the width formed of the line defect of the lattice points from the directional coupling unit.

7. The directional coupler according to claim 1, wherein
a length of the directional coupling unit is equal to a length of the second two dimensional photonic crystal waveguide.

8. The directional coupler according to claim 7, wherein
a length of the second two dimensional photonic crystal waveguide is equal to a coupling length.

9. The directional coupler according to claim 8, wherein
the coupling length is equal to 4 times of a period of the lattice points.

10. The directional coupler according to claim 1, wherein
the lattice points are arranged in any one selected from the group consisting of a square lattice, a rectangular lattice, a face-centered rectangle lattice, and a triangular lattice.

11. The directional coupler according to claim 1, wherein
the lattice point is provided with one selected from the group consisting of a polygonal shape, a circular shape, an ellipse shape, and an oval shape.

12. The directional coupler according to claim 1, wherein
the lattice points and the lattice points between waveguides are arranged at a triangular lattice, and formed in a circular hole, wherein
a radius of the lattice points between waveguides is smaller than a radius of the lattice point, and is equal to 0.23 time of the period of the lattice points.

13. The directional coupler according to claim 5, wherein
the lattice points and the lattice points between waveguides are arranged at a triangular lattice, and formed in a circular hole, wherein
a width of the second two dimensional photonic crystal waveguide is formed to be narrowed for 0.15 time of the period of the lattice points.

14. The directional coupler according to claim 6, wherein
the lattice points and the lattice points between waveguides are arranged at a triangular lattice, and formed in a circular hole, wherein
a width of the first two dimensional photonic crystal waveguide at a side of the second port from the directional coupling unit is formed to be narrowed for 0.15 time of the period of the lattice points.

15. The directional coupler according to claim 1, wherein
the two dimensional photonic crystal slab is formed with a semiconducting material.

16. The directional coupler according to claim 15, wherein
one selected from the group consisting of silicon (Si), GaAs, InP, GaN, GaInAsP/InP based, InGaAs/GaAs based, GaAlAs/GaAs based or GaInNAs/GaAs based, GaAlInAs/InP based, AlGaInP/GaAs based, and GaInN/GaN based material is applicable to the semiconducting material.

17. The directional coupler according to claim 1, wherein
a plurality of the directional couplers are connected thereto in parallel.

18. The directional coupler according to claim 4, wherein
the first port comprises a first adiabatic mode converter disposed at an edge face of the photonic crystal slab to which the first two dimensional photonic crystal waveguide extended, the two dimensional photonic crystal waveguide extended to the first adiabatic mode converter.

19. The directional coupler according to claim 4, wherein
the second port comprises a second adiabatic mode converter disposed at an edge face of the photonic crystal slab to which the first two dimensional photonic crystal waveguide extended, the two dimensional photonic crystal waveguide extended to the second adiabatic mode converter.

20. The directional coupler according to claim 6, wherein
the third port comprises a third adiabatic mode converter disposed at an edge face of the photonic crystal slab to which the first two dimensional photonic crystal waveguide extended, the two dimensional photonic crystal waveguide extended to the third adiabatic mode converter.

21. The directional coupler according to claim 18, wherein
the adiabatic mode converter, in a planar view of the two dimensional photonic crystal slab, may have a tapered shape so that a tip part becomes thinner as being distanced from the edge face of the two dimensional photonic crystal slab.

22. A multiplexer and demultiplexer comprising a directional coupler, the directional coupler comprising:
a two dimensional photonic crystal slab;
lattice points periodically arranged in the two dimensional photonic crystal slab, the lattice points configured to diffract optical waves, terahertz waves, or millimeter waves in photonic bandgap frequencies in photonic band structure of the two dimensional photonic crystal slab in order to prohibit existence in a plane of the two dimensional photonic crystal slab;
a first two dimensional photonic crystal waveguide disposed in the two dimensional photonic crystal slab and formed with a line defect of the lattice points;
a second two dimensional photonic crystal waveguide formed of a line defect of the lattice point in the two dimensional photonic crystal slab, mode coupling of the second two dimensional photonic crystal waveguide being realized to the first two dimensional photonic crystal waveguide; and
a directional coupling unit disposed between the first two dimensional photonic crystal waveguide and the second two dimensional photonic crystal waveguide, the directional coupling unit including lattice points between waveguides, the size of the lattice points between waveguides is smaller than that of the lattice point.

23. The multiplexer and demultiplexer according to claim 22, further comprising:
an input/output interface coupled to the directional coupler;
a detector coupled to the directional coupler; and
a transmitter coupled to the directional coupler.

24. The multiplexer and demultiplexer according to claim 23, wherein
between the directional coupler and the input/output interface, between the directional coupler and the detector, and between the directional coupler and the transmitter are coupled to each other via a waveguide formed of the line defect of the lattice point of the two dimensional photonic crystal slab.

25. The multiplexer and demultiplexer according to claim 24, wherein
the input/output interface is composed of a grating coupler composed of a one dimensional photonic crystal.

26. The multiplexer and demultiplexer according to claim 24, wherein
the detector is composed of one selected from the group consisting of a terahertz wave receiver mounting a resonant tunneling diode, and a Schottky barrier diode.

27. The multiplexer and demultiplexer according to claim 24, wherein
the transmitter is composed of one selected from the group consisting of a terahertz wave receiver mounting a resonant tunneling diode, and a Schottky barrier diode.
